(19) United States
(12) Patent Application Publication
(10) Pub. No.: US 2024/0361015 A1
(43) Pub. Date: Oct. 31, 2024

(54) HUMIDIFIER

(71) Applicant: LG ELECTRONICS INC., Seoul (KR)

(72) Inventors: Myungjin KU, Seoul (KR); Sangheon LEE, Seoul (KR); Kunyoung LEE, Seoul (KR); Yeongcheol MUN, Seoul (KR); Suchan LIM, Seoul (KR); Chanho HWANG, Seoul (KR); Junehee KIM, Seoul (KR)

(21) Appl. No.: 18/644,610

(22) Filed: Apr. 24, 2024

(30) Foreign Application Priority Data
Apr. 27, 2023 (KR) 10-2023-0055146
Jan. 31, 2024 (KR) 10-2024-0014939

(51) Int. Cl. F24F 6/02; F24F 6/00; F24F 6/12

(52) U.S. Cl. CPC F24F 6/025; F24F 6/12; F24F 2006/008

(57) ABSTRACT

A humidifier may include a humidifying device that generates humidified air, and a flow path unit that is disposed at an upper side of the humidifying device and guides humidified air. The flow path unit may include an inner shell that opens upward and through which humidified air generated by the humidifying device flows, and a water tank that is disposed inside of the inner shell and supplies stored water to the humidifying device. A discharge flow path through which humidified air flows may be formed between the inner shell and the water tank, and the inner shell may be detachably coupled to an upper side of the humidifying device.

### CROSS-REFERENCE TO RELATED APPLICATION(S)

This application claims priority under 35 U.S.C. § 119 to Korean Application Nos. 10-2023-0055146 and 10-2024-0014939 filed in Korean on Apr. 27, 2023 and Jan. 31, 2024, respectively, whose entire disclosures are hereby incorporated by reference.

### BACKGROUND

### 1. Field

A humidifier is disclosed herein.

### 2. Background

A humidifier is a device that vaporizes water and discharges humidified air with a high moisture content. A humidifier may generate humidified air by vaporizing water through natural evaporation, heated evaporation, or ultrasonic vibration.

A ‘humidifier’ disclosed in the Korea registered patent No. 10-2346621, which is hereby incorporated by reference, includes a case having an inlet formed on a side surface and an upward-facing outlet; a water tank installed inside of the case; a rotating disk assembly disposed in the water tank supplying moisture to the air drawn in through the inlet; and an inner case disposed on an upper side of the disk assembly and coupled to the case to guide an air flow to the outlet.

Conventional humidifiers have a large number of components disposed inside of a case with a small volume, which makes it difficult for a user to disassemble the humidifier. Also, due to the complexity of disassembling the humidifier, users may encounter difficulties in cleaning and maintaining the humidifier's internal flow path structure, resulting in degraded hygiene conditions.

Further, as the water tank containing water is disposed at a bottom of the humidifier and a plurality of components are disposed on an upper side of the water tank, users may not easily separate only the water tank to refill water. Also, as many components are assembled in a complex structure, users may find it difficult to reassemble the components back to their original configuration after disassembly.

A ‘water level control humidifier based on water tank weighing’ disclosed in the Korea registered patent No. 10-2022-0080856, which is hereby incorporated by reference, includes a housing in which a water tank that stores water is formed, an ultrasonic vibrator disposed at a bottom of the water tank, and a plurality of weight measurement sensors disposed on a lower surface of the housing; and measures a level of water stored in the water tank based on a weight detected by the plurality of weight measurement sensors. Conventional humidifiers are constructed with weight measurement sensors disposed on the lower surface of the housing to detect an entire load of the humidifier, which prevents accurate weight measurement. As weight measurement sensors bear the entire load of the humidifier, they are prone to malfunction and potential damage. Further, because of the integrated structure of the water tank and the weight measurement sensors, the weight measurement sensors become submerged while the water tank is being cleaned.

### BRIEF DESCRIPTION OF THE DRAWINGS

Embodiments will be described in detail with reference to the following drawings in which like reference numerals refer to like elements, and wherein:

FIG. 1 is a perspective view of a humidifier according to one embodiment;

FIG. 2 is a simplified view of a humidifier according to one embodiment;

FIG. 3 is a longitudinal cross-sectional view of a blower according to one embodiment;

FIG. 4 is a longitudinal cross-sectional view of a humidifying device according to one embodiment;

FIG. 5 illustrates a humidifying device and a flow path unit according to one embodiment;

FIG. 6 is a perspective view of a flow path unit according to one embodiment;

FIG. 7 is an exploded view of the assembly of a flow path unit according to one embodiment;

FIG. 8 is a perspective view of an outer shell according to one embodiment;

FIG. 9 is a cross-sectional perspective view of an outer shell according to one embodiment;

FIG. 10 is a perspective view of a middle tray according to one embodiment;

FIG. 11 is a cross-sectional view of the outer shell in an assembled state according to one embodiment;

FIG. 12 is a perspective view of an inner shell according to one embodiment;

FIG. 13 is a cross-sectional perspective view of an inner shell according to one embodiment;

FIG. 14 is a bottom perspective view of an inner shell according to one embodiment;

FIG. 15 is a cross-sectional perspective view of a middle tray according to one embodiment;

FIG. 16 is an exploded view of the assembly of an inner shell and a middle tray according to one embodiment;

FIG. 17 is a cross-sectional view of an inner shell in an assembled state according to one embodiment;

FIG. 18 is a perspective view of a water tank housing according to one embodiment;

FIG. 19 is a cross-sectional perspective view of a water tank housing according to one embodiment;

FIG. 20 is a bottom perspective view of a water tank housing according to one embodiment;

FIG. 21 is an exploded view of the assembly of a water tank housing, an inner shell, and a middle tray according to one embodiment;

FIG. 22 is a cross-sectional perspective view of a water tank housing, an inner shell, and a middle tray in an assembled state according to one embodiment;

FIG. 23 is a cross-sectional view of a middle tray according to one embodiment;

FIG. 24 is a perspective view of a water tank according to one embodiment;

FIG. 25 is a cross-sectional view of a water tank according to one embodiment;

FIG. 26 is a cross-sectional perspective view of a water tank, a water tank housing, an inner shell, and a middle tray according to one embodiment;

FIG. 27 is a cross-sectional perspective view of a humidifier according to one embodiment;

FIG. 28 is a perspective view of a middle tray according to one embodiment;

FIG. 29 is a cross-sectional perspective view of a middle tray according to one embodiment;

FIG. 30 is a longitudinal perspective view of a middle tray according to one embodiment;

FIG. 31 is a planar view of a portion of a middle tray according to one embodiment;

FIG. 32 is a cross-sectional view of a portion of a flow path unit according to one embodiment; and

FIG. 33 is a magnified view of S2 of FIG. 32.

### DETAILED DESCRIPTION

Hereinafter, embodiments disclosed in this document will be described with reference to appended drawings, where the same or similar components are given the same reference number irrespective of their drawing symbols, and repetitive description has been omitted.

The suffixes “module” and “unit” for the constituting elements used in the following descriptions are assigned or used interchangeably only for the convenience of writing and do not have separate meanings or roles distinguished from each other.

Also, in describing an embodiment disclosed herein, if it is determined that a detailed description of a related art incorporated herein unnecessarily obscures the gist of the embodiment, the detailed description thereof has been omitted. Also, it should be understood that the appended drawings are intended only to help understand embodiments disclosed in the present document and do not limit the technical principles and scope; rather, it should be understood that the appended drawings include all of the modifications, equivalents, or substitutes belonging to the technical principles and scope.

Also, terms including an ordinal number such as first or second may be used to describe various constituting elements, but the constituting elements should not be limited by these terms. Those terms are used only for the purpose of distinguishing one constituting element from the others.

If an element is said to be “connected” or “attached” to a different element, the former may be connected or attached directly to the different element, but another element may be present between the two elements. On the other hand, if an element is said to be “directly connected” or “directly attached” to a different element, it should be understood that there is no other element between the two elements.

It should be understood that the singular expression includes the plural expression unless the context clearly indicates otherwise.

The term “includes” or “have” used herein specifies the presence of stated features, numerals, steps, operations, components, parts, or a combination thereof but does not preclude the presence or addition of one or more other features, numerals, steps, operations, components, parts, or a combination thereof.

The direction indications of up (U), down (D), left (Le), right (Ri), front (F), rear (R), and outside (O) shown in the accompanying drawings are introduced only for the convenience of description, and it should be understood that the technical principles disclosed herein are not limited by the indications.

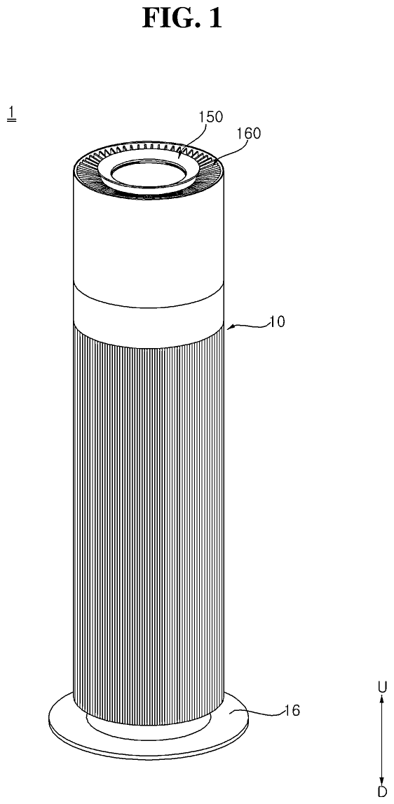

Referring to FIG. 1, a humidifier 1 may include a case 10 forming an external appearance, a discharge grill 160 and a water tank cover 150 coupled to the case 10, and a stand 16 coupled to a lower side of the case 10.

The case 10 may form the external appearance of the humidifier 1. The case 10 may have an elongated structure in a vertical direction. For example, the case 10 may have a cylindrical shape extending in the vertical direction. A space may be formed within the case 10. A humidifying device 200, which will be described hereinafter, may be disposed in the internal space of the case 10.

The case 10 may have an inlet (not shown). The inlet may be a through hole formed in the case 10. The inlet may be formed on a side surface of the case 10. The inlet may be formed along a peripheral surface of the case 10. For example, the inlet may be a through hole formed along the peripheral surface of the case 10, and air may flow into the case 10 through the inlet.

The case 10 may include an outlet (unmarked). Humidified air may be discharged from the case 10 through the outlet of the case 10. The outlet may be formed on an upper side of the case 10. The upper side of the case 10may be open. The outlet may be an opening formed on the upper side of the case 10. For example, the outlet may be an annular outlet opened on the upper surface of the cylindrical case 10. Indoor air introduced through the inlet may be discharged through the outlet together with the humidified air.

The humidifier 1 may include the stand 16 that supports the case 10. The stand 16 may be disposed on a lower side of the case 10. The stand 16 may be fixed to the case 10. The stand 16 may prevent the case 10 from tipping over. A diameter of the stand 16 may be larger than a diameter of the case 10. An outer periphery of the stand 16 may be located outside of a peripheral wall of the case 10 in a horizontal direction.

The discharge grill 160 may be disposed at the outlet. The discharge grill 160 may be disposed on the open upper side of the case 10. The discharge grill 160 may form an upper surface of the case 10. Humidified air may pass through the discharge grill 160 and be supplied to an indoor space.

The water tank cover 150 may be disposed on the open upper side of the case 10. The water tank cover 150 may be disposed at a center of the discharge grill 160. The discharge grill 160 may be disposed outside of the water tank cover 150. The water tank cover 150 may cover a water tank 110, which will be described hereinafter. The water tank cover 150 may be a lid of the water tank 110. The water tank cover 150 may be detached from the discharge grill 160. For example, the user may supply water to the water tank 110 by separating the water tank cover 150 from the discharge grill 160. After supplying water, the user may couple the water tank cover 150 to the discharge grill 160.

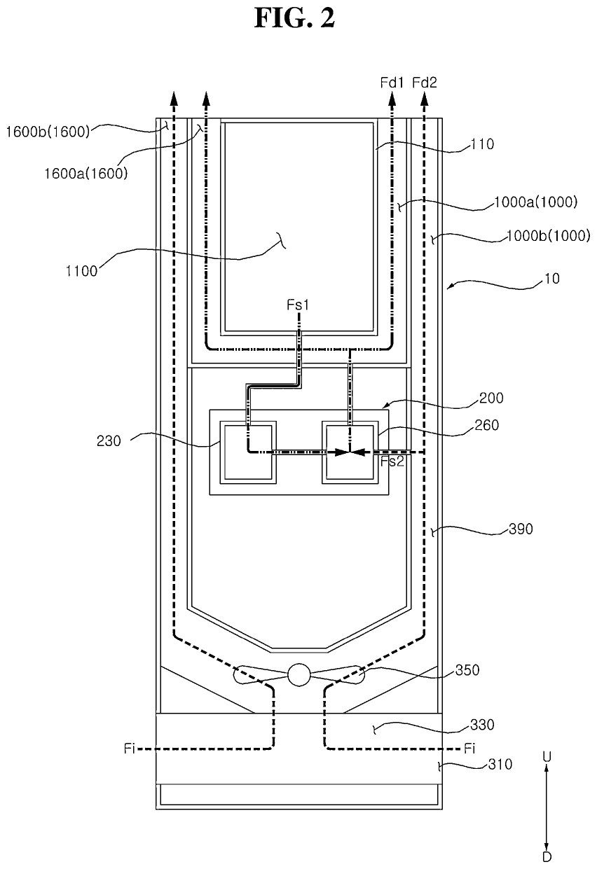

Referring to FIG. 2, the humidifier 1 may include a blower fan 350 forming an airflow, the humidifying device 200 that generates humidified air, and a discharge flow path 1000 through which the humidified air is discharged. Indoor air may be introduced through an inlet 310 formed in the case 10 (flow path Fi). The inlet 310 may be formed in or at a lower portion of the case 10. Air introduced into the case 10 may flow through a flow path formed inside (flow path Fi) of the case 10. The air flowing inside of the case 10 may be discharged back into the indoor space through an outlet 1600 formed on the upper side (Fi). A humidity of the discharged air may be higher than a humidity of the inhaled air.

The water tank 110 may store water. The water tank 110 may include a storage space 1100 in which water is stored. Water stored in the water storage space 1100 may be supplied to the humidifying device 200 (flow path Fs1). The humidifying device 200 may generate humidified air using the supplied water.

The humidifying device 200 may generate humidified air. Humidified air may contain mist and/or water vapor. In other words, humidified air may refer to air containing mist and/or water vapor. The humidity of humidified air may be higher than that of indoor air.

The humidifying device 200 may include a water heater tank 230. Water supplied from the water tank 110 may flow into the water heater tank 230 (Fs1). The water heater tank 230 may heat water supplied from the water tank 110. The water heater tank 230 may sterilize the supplied water by heating it.

The humidifying device 200 may include a water humidifier tank 260. The water sterilized in the water heater tank 230 may move to the water humidifier tank 260 (Fs1). The water humidifier tank 260 may generate humidified air using water supplied from the water heater tank 230. The water humidifier tank 260 may generate humidified air using any one of an ultrasonic-based method, a heating method, an evaporation method, or a disk method, for example. For example, the water humidifier tank 260 may generate humidified air by atomizing supplied water using an ultrasonic vibrator.

The blower fan 350 may be disposed inside of the case 10. The blower fan 350 may be disposed below the humidifying device 200. The blower fan 350 may form an airflow flowing inside of the case. The blower fan 350 may form an airflow flowing from the inlet 310 to the outlet 1600 (Fi). For example, the blower fan 350 may form an upward airflow that flows from the inlet 310 formed in the lower portion of the case 10 to the outlet 1600 formed on the upper surface of the case 10.

The case 10 may include a blower flow path 390. The blower flow path 390 may be formed inside of the case 10. The blower flow path 390 may be a flow path through which air blowing from the blower fan 350 flows. Air introduced through the inlet 310 may flow to the blower fan 350 through a suction flow path 330 (Fi). Air passing through the blower fan 350 may flow through the blower flow path 390 (Fi).

The case 10 may include a discharge flow path 1000. The discharge flow path 1000 may be formed inside of the case 10. Air passing through the blower flow path 390 may flow into the discharge flow path 1000 (Fd). The discharge flow path 1000 may be located above the blower flow path 390. The discharge flow path 1000 may be located on or at a downstream side of the blower flow path 390.

The discharge flow path 1000 may include a first discharge flow path 1000a and a second discharge flow path 1000b. The outlet 1600 may include a first outlet 1600a corresponding to the first discharge flow path 1000a and a second outlet 1600b corresponding to the second discharge flow path 1000b. The second discharge flow path 1000b may be formed inside of the case 10. The first discharge flow path 1000a may be formed inside of the second discharge flow path 1000b.

The second discharge flow path 1000b may be connected to the blower flow path 390. The second discharge flow path 1000b may be located on or at the downstream side of the blower flow path 390. Some of the air that has passed through the blower flow path 390 may rise through the second discharge flow path 1000b (flow path Fd2). Air that has passed through the second discharge flow path 1000b may be supplied to the indoor space through the second outlet 1600b (Fd2).

The remaining portion of the air that has passed through the blower flow path 390 may flow to the humidifying device 200 (flow path Fs2). The remaining portion of the air that has passed through the blower flow path 390 may flow into the water humidifier tank 260 (Fs2). The remaining portion of the air introduced into the water humidifier tank 260 may flow into the first discharge flow path 1000a together with the humidified air generated in the water humidifier tank 260 (flow path Fd1). Humidified air flowing through the first discharge flow path 1000a may be supplied to the indoor space through the first outlet 1600a (Fd1).

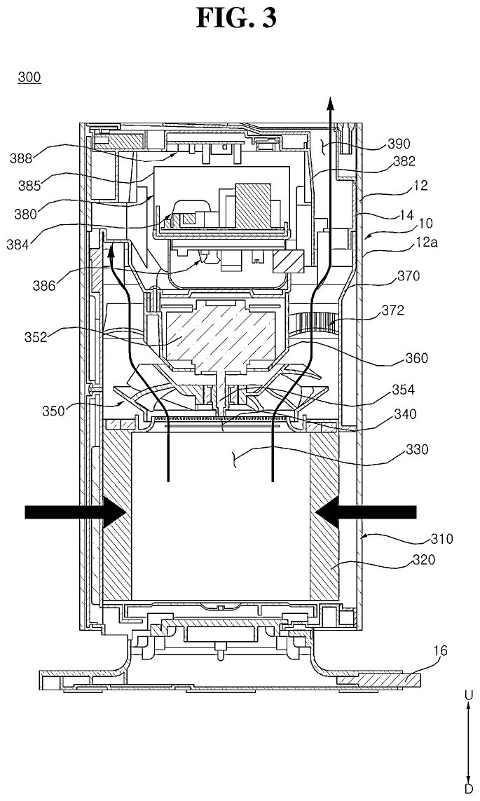

Hereinafter, a blower 300 that forms a rising airflow will be described with reference to FIG. 3. Indoor air may be drawn into the blower 300 through the inlet 310 formed in the case 10. The blower 300 may include a filter 320 that filters the drawn air. The filter 320 may be disposed inside of the case 10. For example, the filter 320 formed in a cylindrical shape may be disposed inside of the cylindrical case 10. The air that has passed through the filter 320 may flow to the blower fan 350 through the suction flow path 330. The suction flow path 330 may be formed inside of the filter 320.

The blower 300 may include an orifice 340 located between the blower fan 350 and the filter 320. The orifice 340 may be a hole through which drawn air passes. The orifice 340 may be located between the suction flow path 330 and the blower flow path 390. The orifice 340 may connect the suction flow path 330 and the blower flow path 390. The orifice 340 may correspond to an inlet (unmarked) formed in the blower fan 350. In other words, the orifice 340 may correspond to an inlet formed in a shroud of the blower fan 350. The drawn air may flow from the suction flow path 330 to the blower fan 350 through the orifice 340 and may flow into the blower flow path 390 by rotation of the blower fan 350.

The blower 300 may include a blower motor 352 that rotates the blower fan 350. The blower motor 352 may be connected to the blower fan 350. For example, a shaft 354 of the blower motor 352 may be connected to the blower fan 350. The blower motor 352 may be disposed above the blower fan 350. The shaft 354 may extend downward from the blower motor 352 and may be connected to a hub of the blower fan 350. As the blower motor 352 is driven, the blower fan 350 rotates, and an airflow may be formed.

The blower 300 may include a motor cover 360 on which the blower motor 352 is disposed. The blower motor 352 may be accommodated in the motor cover 360. The blower motor 352 may be disposed inside of the motor cover 360, and the blower fan 350 may be disposed outside of the motor cover 360. For example, the blower fan 350 may be disposed below the motor cover 360. The shaft 354 of the blower motor 352 may penetrate the motor cover 360.

The blower 300 may include a blower housing 370 that forms the blower flow path 390. The blower housing 370 may be disposed inside of the case 10. The blower fan 350 and the blower motor 352 may be disposed inside of the blower housing 370. The blower flow path 390 may be formed between the motor cover 360 and the blower housing 370. The blower housing 370 may extend in the vertical direction.

The case 10 may include an inner case 14 and an outer case 12. The outer case 12 may form an outer shape of the case 10. The outer case 12 may include a plurality of louvers 12a. A plurality of louvers 12a may be arranged along a periphery of the outer case 12.

The inner case 14 may be disposed inside of the outer case 12. The inner case 14 may be disposed on an upper side of the blower housing 370. For example, the inner case 14 and the blower housing 370 may be disposed inside of the outer case 12, and the inner case 14 may be coupled to the upper side of the blower housing 370.

The blower flow path 390 may be formed inside of the case 10. The blower flow path 390 may extend in the vertical direction inside of the case 10. The blower flow path 390 may have an annular cross section, for example. The blower flow path 390 may be located on or at a downstream side of the blower fan 350. The blower fan 350 may be located between the suction flow path 330 and the blower flow path 390. The motor cover 360 may be disposed inside of the blower housing 370. The blower flow path 390 may be formed between the motor cover 360 and the blower housing 370.

An electric unit 380 may be disposed on an upper side of the blower motor 352. The electric unit 380 may be disposed inside of the inner case 14. The blower flow path 390 may be formed between the electric unit 380 and the inner case 14. Accordingly, the drawn air may be directed to the humidifying device 200 along the blower flow path 390 by the blower fan 350.

The blower 300 may include an air diffuser 372 disposed in the blower flow path 390. The air diffuser 372 may control a direction of the air flow flowing through the blower flow path 390. For example, the air diffuser 372 may straighten the air flow flowing through the blower flow path 390. The air diffuser 372 may be disposed outside of the motor cover 360. The air diffuser 372 may be disposed inside of the blower housing 370. For example, the air diffuser 372 may include a plurality of air diffusers 372 disposed between the motor cover 360 and the blower housing 370, and the plurality of air diffusers 372 may be separated from each other along a circumferential direction of a horizontal cross-section of the blower flow path 390. A flow path may be formed between the plurality of air diffusers 372.

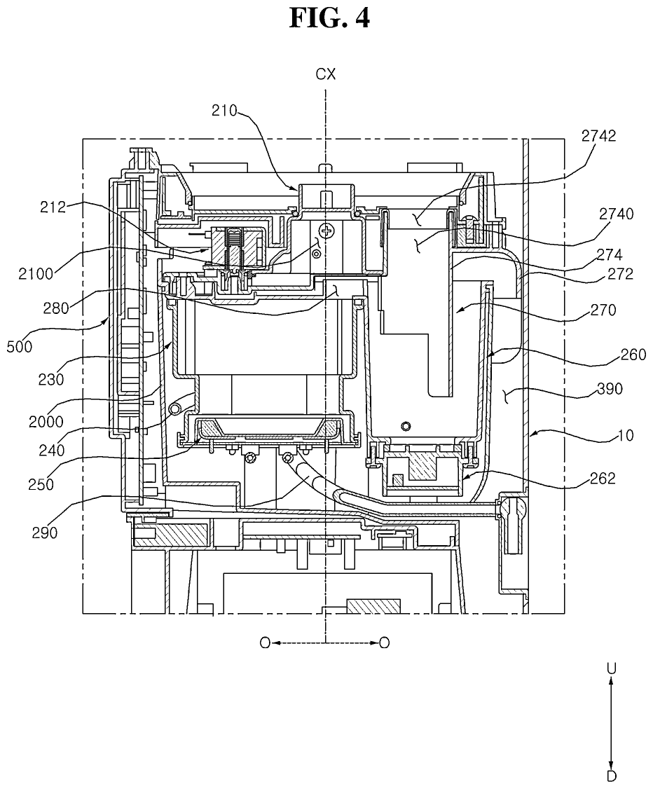

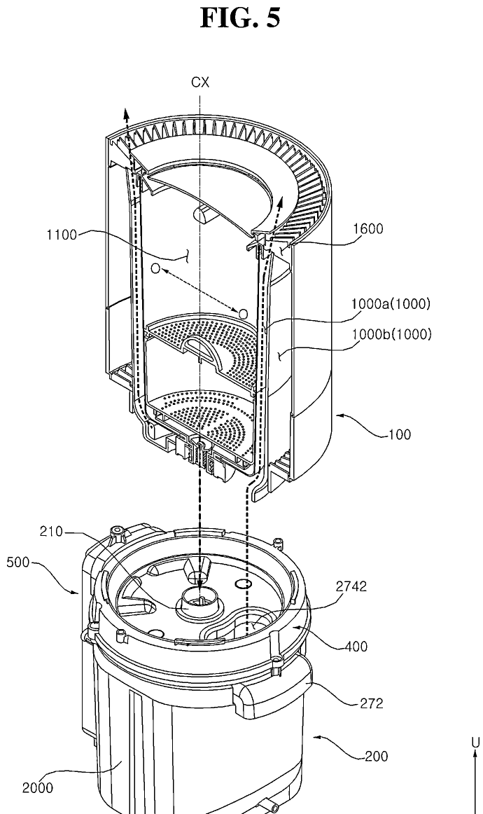

The humidifying device 200 that generates humidified air will be described with reference to FIGS. 4 and 5. The humidifying device 200 may include a main housing 2000. The main housing 2000 may form an external appearance of the humidifying device 200. The main housing 2000 may be disposed inside of the case 10. The main housing 2000 may accommodate the water heater tank 230 and the water humidifier tank 260, which will be described hereinafter. The main housing 2000 may have an opening on an upper side thereof.

The humidifying device 200 may include a supply pipe 210. The supply pipe 210 may be a pipe through which water is supplied to the humidifying device 200. The supply pipe 210 may be connected to the humidifying device 200. Water stored in the water tank 110 may be supplied to the humidifying device 200 through the supply pipe 210. For example, water stored in the water tank 110 may be moved to the water heater tank 230 through the supply pipe 210. The humidifying device 200 may generate humidified air using water supplied through the supply pipe 210. The supply pipe 210 may be disposed on an upper side of the humidifying device 200. The supply pipe 210 may extend upward. For example, water stored in the water storage space 1100 located above the humidifying device 200 may flow in through the supply pipe 210 disposed above the humidifying device 200.

A supply chamber 2100 may be formed inside of the supply pipe 210. Water flowing into the supply pipe 210 may pass through the supply chamber 2100 and flow into the water heater tank 230. Water flowing into the supply pipe 210 may be temporarily stored in the supply chamber 2100.

The humidifying device 200 may include a humidified air outlet 2742. Humidified air generated by the humidifying device 200 may be discharged through the humidified air outlet 2742. The humidified air outlet 2742 may be formed on the upper side of the humidifying device 200. The humidified air outlet 2742 may be open on an upper surface of the humidifying device 200.

The humidifying device 200 may include a first valve 212. The first valve 212 may control a flow of water supplied to the humidifying device 200 through the supply pipe 210. For example, when the first valve 212 is opened, water stored in the supply chamber 2100 may move to the water heater tank 230. Conversely, when the first valve 212 is closed, the supplied water may be temporarily stored in the supply chamber 2100. The first valve 212 may be opened and closed according to an electric signal from the electric unit 380. The first valve 212 may receive power from the electric unit 380. For example, the first valve 212 may be a solenoid valve. The first valve 212 may be disposed on an upper side of the water heater tank 230. The first valve 212 may be disposed in the supply pipe 210. For example, the first valve 212 may be disposed between the water heater tank 230 and the supply pipe 210. The first valve 212 may be separated upward from the water heater tank 230. For example, the first valve 212 may be separated upward from the upper surface of the water heater tank 230.

The humidifying device 200 may include the water heater tank 230. The water heater tank 230 may be disposed inside of the main housing 2000. The water heater tank 230 may heat water introduced through the supply pipe 210. The water heater tank 230 may sterilize water by heating it. Water heated in the water heater tank 230 may flow into the water humidifier tank 260.

The humidifying device 200 may include a first connector 240. The first connector 240 may be a pipe through which water stored in the water heater tank 230 flows into the water humidifier tank 260. A height of the first connector 240 may decrease as it extends downstream. The first connector 240 may be inclined downward toward a downstream side. The first connector 240 may have a high thermal conductivity. A temperature of water heated in the water heater tank 230 may be lowered while flowing through the first connector 240.

The humidifying device 200 may include a drain pipe 290. The drain pipe 290 may be connected to the water heater tank 230. The drain pipe 290 may discharge residual water stored in the water heater tank 230. The remaining water may be discharged to the outside of the case 10 through the drain pipe 290. The drain pipe 290 may be connected to a lower portion of the water heater tank 230. For example, the drain pipe 290 may be connected to a bottom surface of the water heater tank 230.

The humidifying device 200 may include the water humidifier tank 260. The water humidifier tank 260 may generate humidified air using supplied water. Humidified air may refer to air containing mist and/or water vapor. The water humidifier tank 260 may generate humidified air using any one of an ultrasonic-based method, a heating method, an evaporation method, or a disk method, for example. For example, the water humidifier tank 260 may generate humidified air by atomizing supplied water using an ultrasonic vibrator. The water humidifier tank 260 may be equipped with a vibrator 262.

The vibrator 262 may be disposed on a bottom surface of the water humidifier tank 260. The vibrator 262 may split the supplied water into fine particles using ultrasonic vibration. The vibrator 262 may atomize supplied water electrically. For example, the vibrator 262 may include a piezoelectric element.

The humidifying device 200 may include a compartment cover 270. The compartment cover 270 may be disposed on an upper side of the main housing 2000. The compartment cover 270 may cover an upper side of the water humidifier tank 260. The compartment cover 270 may partition a flow path flowing into the water humidifier tank 260 and a flow path flowing out from the water humidifier tank 260. For example, the compartment cover 270 may include the supply pipe 210, which is a flow path through which a portion of a rising airflow flowing through the blower flow path 390 flows into the water humidifier tank 260 and a discharge pipe 274 through which a portion of the rising airflow introduced into the water humidifier tank 260 and the mist stagnant in the water humidifier tank 260 are discharged together. The air supply pipe 210 may connect the blower flow path 390 and the water humidifier tank 260. The rising airflow that enters the water humidifier tank 260 through the blower flow path 390 may flow by pulling the mist generated in the water humidifier tank 260. With this structure, the mist generated in the water humidifier tank 260 may be discharged. The discharge pipe 274 may extend in the vertical direction. The discharge pipe 274 may form a discharge flow path 2740. A humidified air outlet 2742 may be formed at one end of the discharge pipe 274. The discharge pipe 274 may be inserted into the water humidifier tank 260.

The humidifying device 200 may include a flue flow path 280 that connects the water heater tank 230 and the water humidifier tank 260. The flue flow path 280 may connect an upper portion of the water heater tank 230 and an upper portion of the water humidifier tank 260. In the water heater tank 230, water vapor may be generated in the process of heating supplied water. The generated water vapor may flow into the water humidifier tank 260 through the flue flow path 280. The discharge pipe 274 may be open toward the flue flow path 280. The flue flow path 280 may be connected to the discharge flow path 2740. Water vapor that moves from the water heater tank 230 to the water humidifier tank 260 through the flue flow path 280 may be discharged through the discharge pipe 274. With this structure, the humidified air may contain water vapor generated in the water heater tank 230, mist generated in the water humidifier tank 260, and a rising airflow formed by the blower fan 350.

The humidifier 1 may include a display 500. The display 500 may be disposed on one side of the humidifying device 200. The display 500 may be coupled to one side of the main housing 2000. For example, the display 500 may be coupled to a side surface of the humidifying device 200. The display 500 may be separated from the water humidifier tank 260 in the horizontal direction. The display 500 may be separated in the horizontal direction from the discharge pipe 274 through which humidified air generated in the water humidifier tank 260 is discharged. The supply pipe 210 may be disposed between the display 500 and the discharge pipe 274. For example, the display 500 and the discharge pipe 274 may be arranged on opposite sides in the horizontal direction with respect to a central axis CX of the case 10. In other words, based on the central axis CX of the case 10, the display 500 may be disposed at a front of the case, and the humidified air outlet 2742 may be disposed at a rear of the case, for example.

Referring to FIG. 5, humidified air discharged from the humidifying device 200 may be discharged through the flow path unit 100. The middle tray 400 may be disposed on the upper side of the humidifying device 200. The middle tray 400 may be coupled to the upper surface of the humidifying device 200. The middle tray 400 may be disposed between the humidifying device 200 and the flow path unit 100.

A flow path unit 100 may include the water storage space 1100, the discharge flow path 1000, and the outlet 1600. The water storage space 1100 may be formed inside of the flow path unit 100. Water stored in the water storage space 1100 may be supplied to the humidifying device 200. For example, water stored in the water storage space 1100 may flow into the humidifying device 200 through the supply pipe 210 located in the lower side.

The discharge flow path 1000 may be located inside of the flow path unit 100. The discharge flow path 1000 may be located outside of the water storage space 1100. The discharge flow path 1000 may be located between a peripheral wall of the flow path unit 100 and the water storage space 1100. The discharge flow path 1000 may include the first discharge flow path 1000a located outside of the water storage space 1100 and the second discharge flow path 1000b located outside of the first discharge flow path 1000a. The first discharge flow path 1000a may be located between the water storage space 1100 and the second discharge flow path 1000b. The second discharge flow path 1000b may be located between the first discharge flow path 1000a and the peripheral wall of the flow path unit 100.

Humidified air discharged from the humidifying device 200 may flow through the discharge flow path 1000. For example, humidified air discharged from the humidified air outlet 2742 may flow through the first discharge flow path 1000a. Humidified air flowing through the first discharge flow path 1000a may be supplied to the indoor space through the outlet 1600. The first discharge flow path 1000a and the second discharge flow path 1000b may be joined at the outlet 1600. The first discharge flow path 1000a may be connected to the humidified air outlet 2742. The second discharge flow path 1000b may be connected to the blower flow path 390.

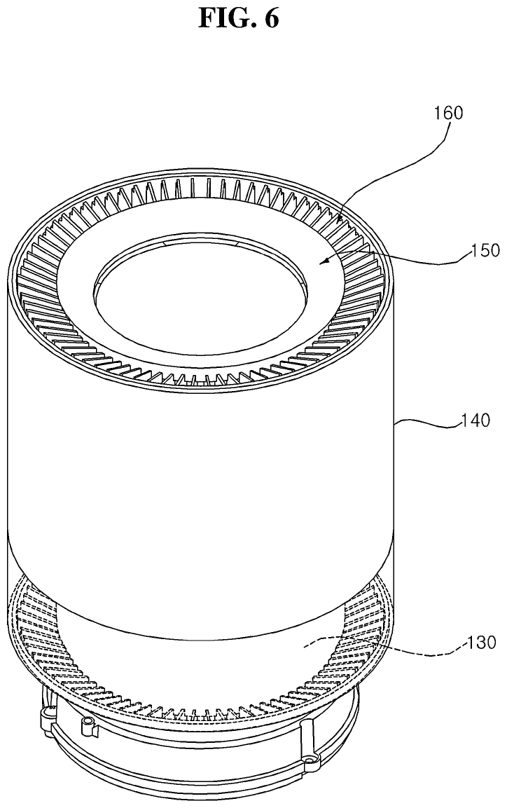

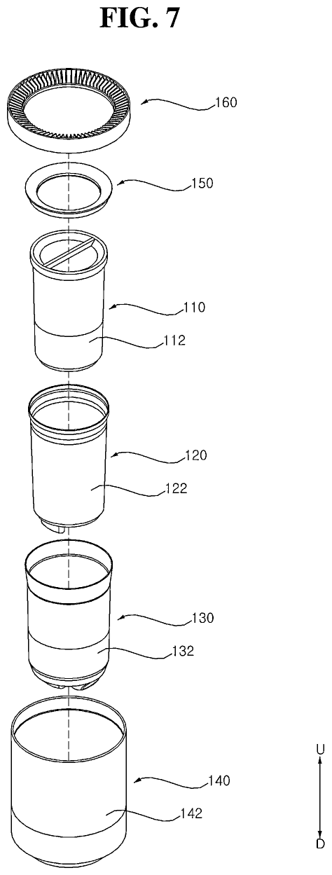

Hereinafter, the flow path unit 100 will be described with reference to FIGS. 6 and 7. The flow path unit 100 may include shells 130, 140. The case 10 may include the shells 130, 140. The shells 130, 140 may define an external appearance of the flow path unit 100. The shells 130, 140 may have a receiving space defined therein. The water tank 110 may be accommodated in the shells 130, 140. The discharge flow path 1000 may be defined inside of the shells 130, 140. An upper side of the shells 130, 140 may be open. The outlet 1600 may be defined on the upper side of the shells 130, 140.

The discharge grill 160 may be disposed on the upper side of the shells 130, 140. The discharge grill 160 may be disposed in the outlet 1600. The discharge grill 160 may be disposed at the upper side of the shells 130, 140. For example, the discharge grill 160 may extend along an inner periphery of a top of the shells 130, 140. The discharge grill 160 may include a plurality of vanes.

The shells 130, 140 may include outer shell 140 that forms an outer shape of the case 10. The outer shell 140 may include an outer peripheral wall 142 that forms an internal space. The outer shell 140 may have a space formed therein. The outer shell 140 may be open upward. For example, the outer shell 140 may be formed in a cylindrical shape with an opening at an upper side.

The shell may include an inner shell 130 disposed inside of the outer shell 140. The inner shell 130 may be detachably coupled to the inside of the outer shell 140. The inner shell 130 may be inserted or pulled out through the open upper side of the outer shell 140. For example, the inner shell 130 may be inserted into the inside of the outer shell 140 through the opening at the upper side of the outer shell 140 or may be pulled out from the inside of the outer shell 140. The inner shell 130 may include an inner peripheral wall 132 that forms an internal space. The inner peripheral wall 132 may be separated inward from the outer peripheral wall 142. The inner shell 130 and the outer shell 140 may be separated from each other in a radial direction. A discharge flow path may be formed between the outer shell 140 and the inner shell 130. The inner shell 130 may be open upward. For example, the inner shell 130 may be formed in a cylindrical shape with an opening in an upper side thereof.

The flow path unit 100 may include a water tank housing 120. The water tank housing 120 may accommodate the water tank 110. The water tank housing 120 may be detachably coupled to an inside of the inner shell 130. The water tank housing 120 may be inserted or pulled out through the open upper side of the inner shell 130. For example, the water tank housing 120 may be inserted into the inside of the inner shell 130 through the opening at the upper side of the inner shell 130 or may be pulled out from the inside of the inner shell 130. The water tank housing 120 may include a housing peripheral wall 122 that forms an internal space. The housing peripheral wall 122 may be separated inward from the inner peripheral wall 132. The housing peripheral wall 122 may contact the inner peripheral wall 132. The water tank housing 120 may be fixed to the inside of the inner shell 130. The water tank housing 120 may be open upward. For example, the water tank housing 120 may be formed in a cylindrical shape with an opening in an upper side thereof.

The flow path unit 100 may include a water tank 110. The water tank 110 may be detachably coupled to the inside of the water tank housing 120. The water tank 110 may be inserted or pulled out through the open upper side of the water tank housing 120. For example, the water tank 110 may be inserted into the water tank housing 120 through the opening at the upper side of the water tank housing 120 or may be pulled out from the inside of the water tank housing 120. The water tank 110 may include a circumferential wall of the water tank 110, which forms the water storage space 1100. The circumferential wall of the water tank 110 may be separated inward from the housing circumferential wall 122. A peripheral wall of the water tank 110 may contact the housing peripheral wall 122. The water tank 110 may be fixed to the inside of the water tank housing 120. The water tank 110 may be open upward. For example, the water tank 110 may be formed in a cylindrical shape with an opening in an upper side thereof.

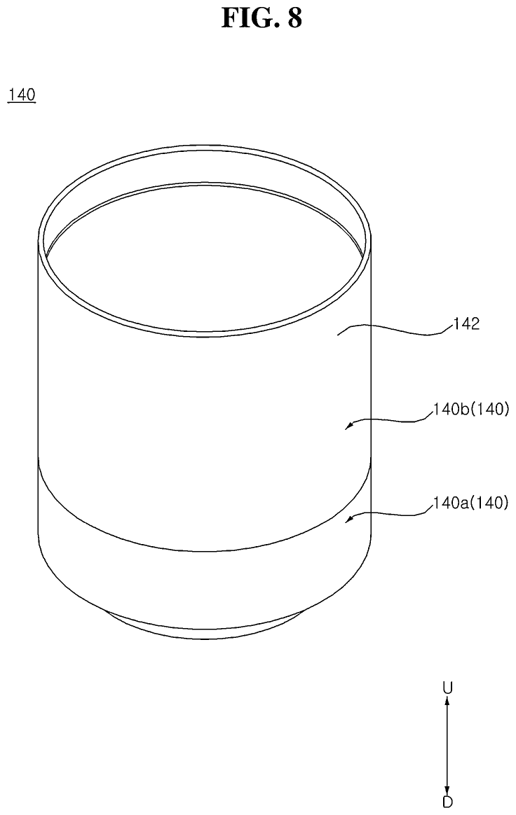

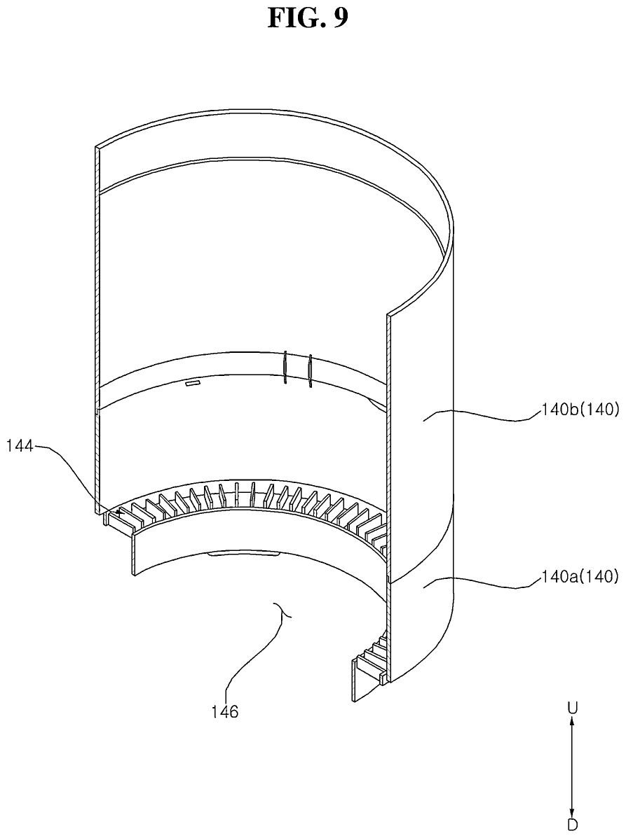

Hereinafter, the outer shell 140 will be described with reference to FIGS. 8 and 9. The shells 130, 140 may include the outer shell 140. The case 10 may include the outer shell 140. The outer shell 140 may form an external appearance of the flow path unit 100. The outer shell 140 may have the internal space. The outer shell 140 may have the opening in the upper side thereof. The outer shell 140 may accommodate at least one of the water tank 110, the water tank housing 120, or the inner shell 130. The outer shell 140 may be separated outward from the water tank 110, the water tank housing 120, and/or the inner shell 130. The discharge flow path 1000 may be formed inside of the outer shell 140. The discharge flow path 1000 may be formed between the outer shell 140 and the water tank 110. For example, the first discharge flow path 1000a may be formed between the water tank housing 120 and the inner shell 130, and the second discharge flow path 1000b may be formed between the inner shell 130 and the outer shell 140. The outer shell 140 may include the outer peripheral wall 142 that partitions the internal space.

The outer shell 140 may include a first outer shell 140a, and a second outer shell 140b coupled to the upper side of the first outer shell 140a. The first outer shell 140a may be transparent. The first outer shell 140a may be formed of a transparent material, for example. The first outer shell 140a may be formed so that its interior is visible. The first outer shell 140a may be formed of a light-transmissive material, for example. For example, a user may look into the inside through the first outer shell 140a.

The second outer shell 140b may be formed so that its interior is invisible. The second outer shell 140b may be formed to be opaque. The second outer shell 140b may be formed of an opaque material, for example. The second outer shell 140b may extend from a top of the first outer shell 140a. For example, the first outer shell 140a may form a lower portion of the outer shell 140, and the second outer shell 140b may form the remaining portion of the outer shell 140.

The blower grill 144 may be disposed inside of the outer shell 140. The blower grill 144 may extend along an inner periphery of the outer shell 140. For example, the blower grill 144 may be an annular blower grill 144 that extends along an inner periphery of the first outer shell 140a. The blower grill 144 may be disposed on the blower flow path 390. The blower grill 144 may be disposed between the blower flow path 390 and the discharge flow path 1000. The blower grill 144 may be disposed below the second discharge flow path 1000b. The blower grill 144 may be disposed between the inner shell 130 and the outer shell 140. The rising airflow formed by the blower fan 350 may pass through the blower grill 144 and flow into the second discharge flow path 1000b.

The outer shell 140 may include a shell opening 146 open in a lower side thereof. The shell opening 146 may be formed inside of the blower grill 144. The inner shell 130 may be disposed in the shell opening 146.

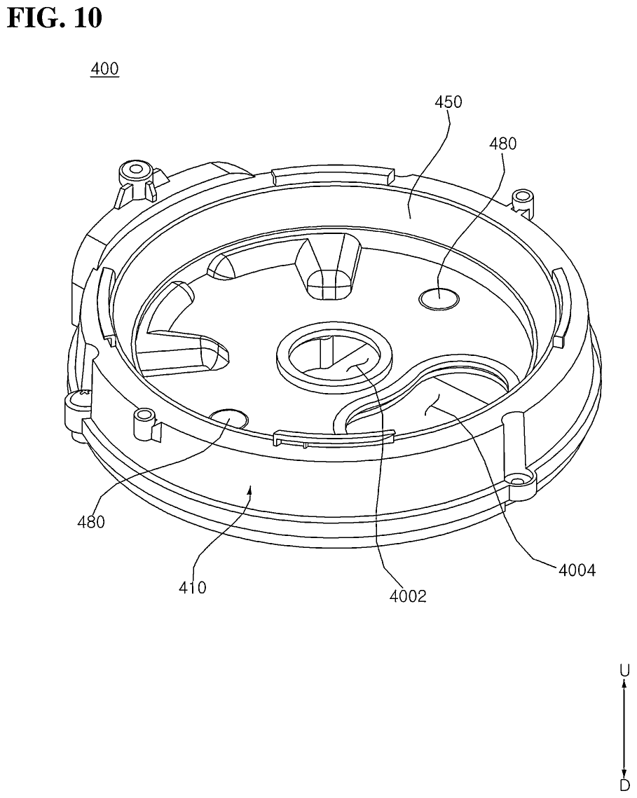

The middle tray 400 will be described with reference to FIG. 10. The middle tray 400 may include a middle housing that forms an external appearance thereof. A periphery of the middle housing 410 may extend in the vertical direction.

The middle tray 400 may include a light diffuser 450. The light diffuser 450 may diffuse light emitted from a light source 462, which will be described hereinafter. The light diffuser 450 may transform the light emitted from the light source 462 in the form of a point light source into a uniform surface light source. The light diffuser 450 may be referred to as a light-scatterer. For example, the light diffuser 450 may be formed of light diffusion resin. The light diffusion resin may refer to a resin having light diffusion properties. For example, the light diffusion resin may be polymethyl methacrylate (PMMA). Also, the light diffusion resin may be acrylonitrile butadiene styrene (ABS).

The light diffuser 450 may form an inner surface of a peripheral wall of the middle tray 400. The light diffuser 450 may be coupled to the middle housing 410. The light diffuser 450 may transmit light emitted from the light source 462 disposed inside of the middle tray 400.

The middle tray 400 may include a load sensor 480 that detects a load. The load sensor 480 may be disposed on an upper surface of the middle tray 400. The load sensor 480 may convert load into an electrical signal. The load sensor 480 may convert displacement in the vertical direction into an electrical signal. A plurality of load sensors 480 may be provided. For example, a pair of load sensors 480 may be disposed on the upper surface of the middle tray 400 and may detect load by converting displacement in the vertical direction into an electrical signal.

The middle tray 400 may include a middle injection hole 4002 so that water stored in the water tank may flow into the humidifying device 200. The supply pipe 210 of the humidifying device 200 may be disposed in the middle injection hole 4002. The supply pipe 210 of the humidifying device 200 may be inserted into the middle injection hole 4002. A location of the middle injection hole 4002 may correspond to a location of a shell injection hole 1302.

The middle tray 400 may include a middle outlet 4004 through which humidified air generated in the humidifying device 200 is discharged. The middle outlet 4004 may correspond to the discharge pipe 274 of the humidifying device 200. The middle outlet 4004 may correspond to a shell inlet 1304. The middle outlet 4004 may be located between outlet pipe 274 and the shell inlet 1304.

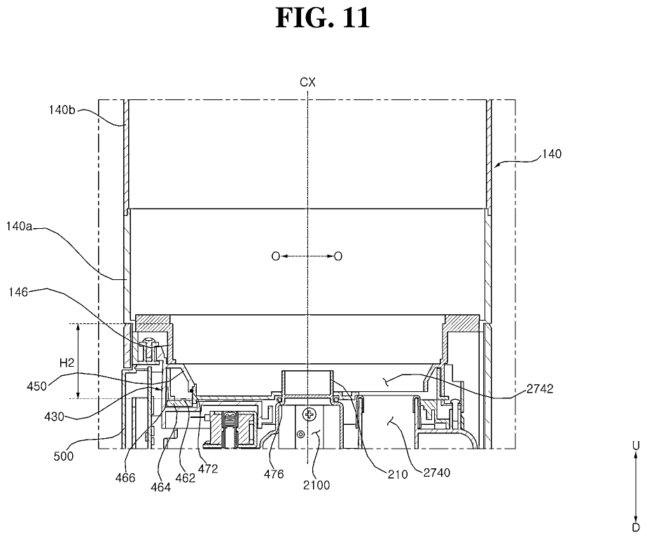

Referring to FIG. 11, the outer shell 140 may be coupled to the upper side of the middle tray 400. The outer shell 140 may be disposed on the upper side of the middle tray 400. The outer shell 140 may form the upper portion of the case 10. Humidified air generated by the humidifying device 200 may be discharged through the humidified air outlet 2742 and introduced into the outer shell 140. The discharged humidified air may flow upward through an interior of the outer shell 140.

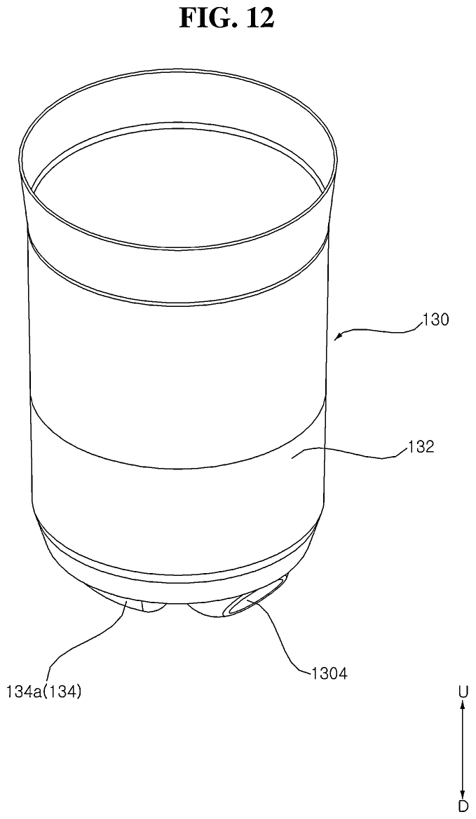

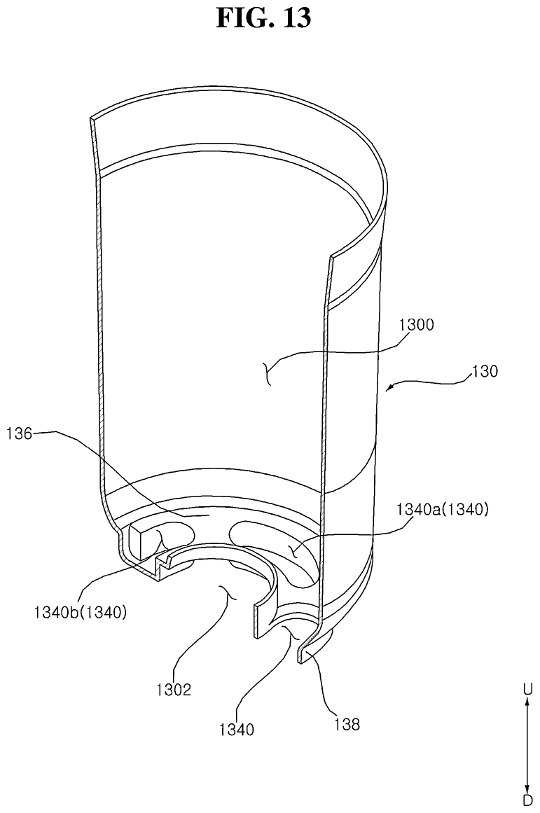

The inner shell 130 will be described with reference to FIGS. 12 and 13. The shells 130, 140 may include the inner shell 130. The case 10 may include the inner shell 130. The inner shell 130 may accommodate the water tank 110 and/or the water tank housing 120. The inner shell 130 may be separated outward from the water tank 110 and/or the water tank housing 120. The first discharge flow path 1000a may be formed between the inner shell 130 and the water tank housing 120. The first discharge flow path 1000a may be formed between the water tank 110 and the inner shell 130. The second discharge flow path 1000b may be formed between the inner shell 130 and the outer shell 140. Humidified air generated from the humidifying device 200 may flow through the first discharge passage 1000a. The inner shell 130 may partition the first discharge flow path 1000a and the second discharge flow path 1000b. The inner shell 130 may include the inner peripheral wall 132 that partitions the internal space.

The inner shell 130 may include an insertion space 1300 in which the water tank 110 and/or the water tank housing 120 is accommodated. The water tank 110 and/or the water tank housing 120 may be inserted into the insertion space 1300 through the open upper side of the inner shell 130. A volume of the insertion space 1300 may be larger than a volume of the water tank 110 and/or the water tank housing 120. The insertion space 1300 may be partitioned by the inner peripheral wall 132.

The inner shell 130 may include a shell support 134. The shell support 134 may extend downward from the inner shell 130. The shell support 134 may be formed on a lower surface of the inner shell 130. The shell support 134 may extend from the lower surface of the inner shell 130. The shell support 134 may support the inner shell 130. The shell support 134 may transfer a load of the inner shell 130 downward.

The inner shell 130 may include a support insertion unit 1340 in which the housing support 124 is disposed. The support insertion unit 1340 may include a first support insertion unit 1340a. The first housing support 124a may be disposed in the first support insertion unit 1340a. The first support insertion unit 1340a may be recessed from a bottom surface 136 of the inner shell 130.

The support insertion unit 1340 may include a second support insertion unit 1340b. The second housing support 124b may be disposed in the second support insertion unit 1340b. The second support insertion unit 1340b may be recessed from the bottom surface 136 of the inner shell 130.

The inner shell 130 may include a shell inlet 1304 through which humidified air flows. The shell inlet 1304 may be formed on the lower surface of the inner shell 130. The shell inlet 1304 may correspond to the humidified air outlet 2742 of the humidifying device 200. For example, humidified air generated from the humidifying device 200 may be discharged through the humidified air outlet 2742, and the discharged humidified air may flow into the inside of the inner shell 130 through the shell inlet 1304. The introduced humidified air may flow through the first discharge flow path 1000a formed inside of the inner shell 130.

The inner shell 130 may include a protruding edge 138 corresponding to the humidified air outlet 2742. The protruding edge 138 may be a periphery that forms the shell inlet 1304. The protruding edge 138 may extend to one side from the periphery forming the shell inlet 1304. The protruding edge 138 may be in close contact with the discharge pipe 274 of the humidifying device 200. The protruding edge 138 may be detachably coupled to the discharge pipe 274 of the humidifying device 200. A cross-sectional shape of the protruding edge 138 may correspond to A cross-sectional shape of the discharge pipe 274 of the humidifying device 200. A lower end of the protruding edge 138 may be located on a same plane as a lower end of the shell support 134. For example, the lower end of the protruding edge 138 may be located on a same horizontal plane as a lower end of a first shell support 134a and a lower end of a second shell support 134b. The protruding edge 138 may support the inner shell 130. The protruding edge 138 may prevent the inner shell 130 from tipping over.

The inner shell 130 may include a shell injection hole 1302 into which an injector 114 is inserted. The shell injection hole 1302 may be formed on the bottom surface 136 of the inner shell 130. The shell injection hole 1302 may be a through hole formed in a center of the bottom surface 136 of the inner shell 130. The periphery forming the shell injection hole 1302 may extend upward. For example, a peripheral wall (unmarked) that extends upward from the periphery of the shell injection hole 1302 may surround the injector 114.

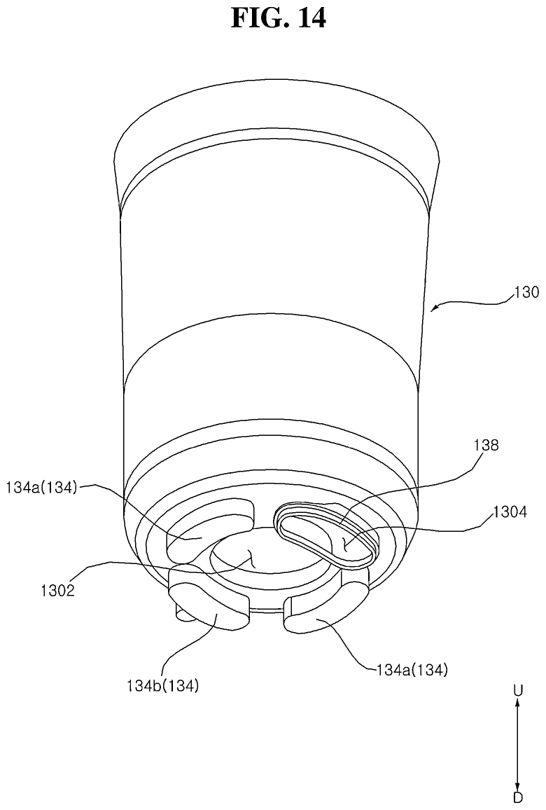

Referring to FIG. 14, the shell support 134 may include the first shell support 134a and the second shell support 134b. The inner shell 130 may include the first shell support 134a. The first shell support 134a may protrude from the inner shell 130. The first shell support 134a may extend from the lower surface of the inner shell 130. For example, the first shell support 134a may extend downward from the lower surface of the inner shell 130. The first shell support 134a may support the inner shell 130. The first shell support 134a may transfer the load of the inner shell 130, the water tank housing 120, and/or the water tank 110 downward. There may be a plurality of first shell supports 134a. A plurality of first shell supports 134a may be separated from each other on the lower surface of the inner shell 130. A plurality of first shell supports 134a may be disposed on the lower surface of the inner shell 130 along a peripheral direction. A plurality of first shell supports 134a may be radially arranged on the lower surface of the inner shell 130. For example, a pair of first shell supports 134a may extend downward from the lower surface of the inner shell 130, and the pair of first shell supports 134a may be positioned in opposite radial directions with respect to a center of the lower surface of the inner shell 130.

The first support insertion unit 1340a may be formed inside of the first shell support 134a. In other words, the first support insertion unit 1340a may be an internal space of the first shell support 134a. The first housing support 124a may be disposed inside of the first shell support 134a. The first housing support 124a may transfer a load to the first shell support 134a. A position of the first shell support 134a may correspond to a position of the first housing support 124a. A number of first shell supports 134a may correspond to a number of first housing supports 124a.

The inner shell 130 may include the second shell support 134b. The second shell support 134b may protrude from the inner shell 130. The second shell support 134b may extend from the lower surface of the inner shell 130. For example, the second shell support 134b may extend downward from the lower surface of the inner shell 130. The second shell support 134b may support the inner shell 130. The second shell support 134b may transfer the load of the inner shell 130. The second shell support 134b may prevent the inner shell 130 from tipping over. The second shell support 134b may be located between the plurality of first shell supports 134a. For example, one pair of first shell supports 134a may be separated in a first radial direction and in the opposite direction of the first radial direction with respect to the center of the lower surface of the inner shell 130, and the second shell support 134b may be located in a second radial direction orthogonal to the first radial direction.

The second support insertion unit 1340b may be formed inside of the second shell support 134b. In other words, the second support insertion unit 1340b may be an internal space of the second shell support 134b. The second housing support 124b may be disposed inside of the second shell support 134b. The second housing support 124b may transfer a load to the second shell support 134b. A position of the second shell support 134b may correspond to a position of the second housing support 124b. A number of second shell supports 134b may correspond to a number of second housing supports 124b.

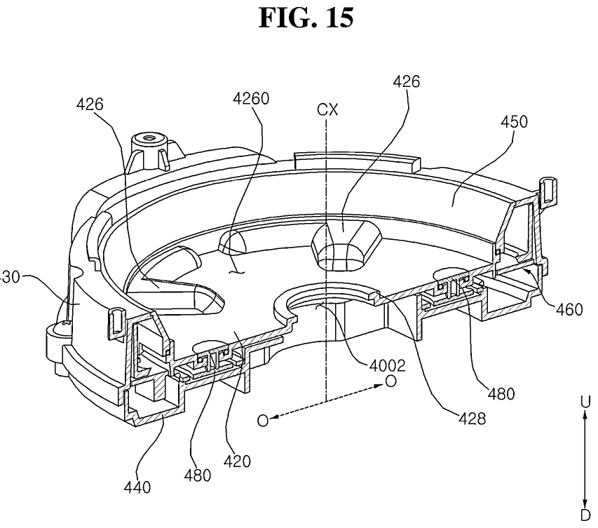

The middle tray 400 will be described with reference to FIG. 15. The middle tray 400 may include a middle cover 430. The middle cover 430 may form an outer periphery of the middle housing 410. The middle cover 430 may be a peripheral wall that extends in the vertical direction. The middle cover 430 may be coupled with the light diffuser 450.

The middle tray 400 may include a middle base 440. The middle housing 410 may include the middle base 440. The middle base 440 may form a lower plate of the middle tray 400. The middle base 440 may be seated on the upper surface of the humidifying device 200. The middle cover 430 may be coupled to the middle base 440. For example, the middle cover 430 may be coupled to an upper side of the middle base 440.

The middle tray 400 may include a middle plate 420. The middle plate 420 may form an upper surface of the middle tray 400. The inner shell 130 may be seated on the middle plate 420. The load of the water tank 110, the water tank housing 120, and/or the inner shell 130 may be transferred to the middle plate 420. The load sensor 480 may be disposed on the middle plate 420.

The middle plate 420 may include a middle injection hole 4002 in which the supply pipe 210 is disposed. The middle injection hole 4002 may be a through hole formed in the middle plate 420. The middle injection hole 4002 may be formed at a center of the middle plate 420.

The middle plate 420 may include an injection rib 428 that protrudes upward from a periphery of the middle injection hole 4002. The injection rib 428 may be a boundary forming the middle injection hole 4002. The middle injection hole 4002 may be located inside of the injection rib 428. The injection rib 428 may protrude upward from the middle plate 420.

The light diffuser 450 may be coupled to the middle plate 420. The light diffuser 450 may be disposed between the middle cover 430 and the middle plate 420. The middle plate 420 may be placed on the upper side of the middle base 440.

The middle plate 420 may include a support seating portion 4260. The second shell support 134b of the inner shell 130 may be seated on the support seating portion 4260. The first shell support 134a of the inner shell 130 may apply pressure to the load sensor 480. The middle plate 420 may include a protruding platform 426 that forms the support seating portion 4260. The protruding platform 426 may protrude upward from the middle plate 420. For example, the support seating portion 4260 may be formed between a pair of protruding platforms 426 that protrude upward. The protruding platform 426 may minimize a horizontal clearance of the second shell support 134b.

The middle tray 400 may include a lighting device 460 that emits light. The lighting device 460 may be disposed inside of the middle housing 410. The lighting device 460 may be disposed between the middle cover 430 and the light diffuser 450. For example, the lighting device 460 may be located outside of the light diffuser 450 in the horizontal direction and may be located inside of the middle cover 320 in the horizontal direction. The lighting device 460 may be disposed below the light diffuser 450. The lighting device 460 may be disposed on an upper side of the middle base 440. Light emitted from the lighting device 460 may pass through the light diffuser 450. For example, light emitted from the lighting device 460 may be diffused while passing through the light diffuser 450. Light emitted from the lighting device 460 may pass through the light diffuser 450 and may be diffused into the case 10.

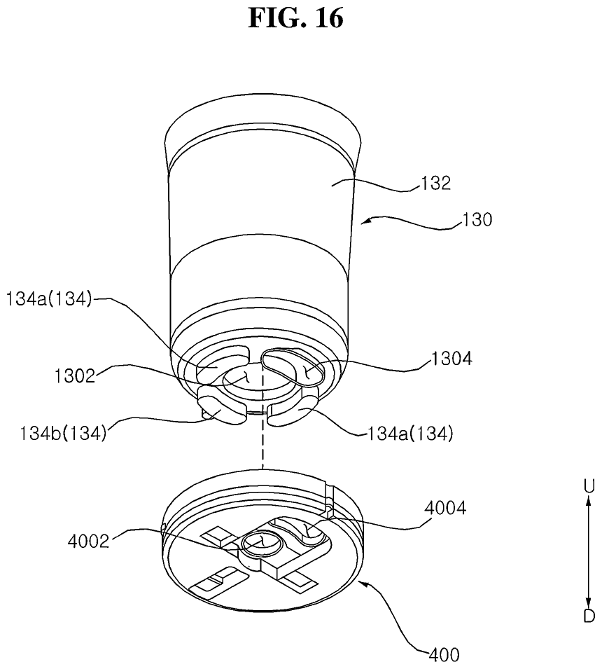

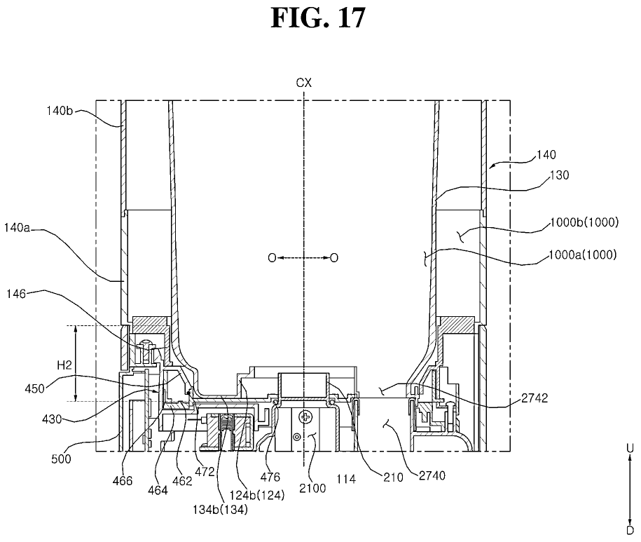

An assembly process for the inner shell 130 and the middle tray 400 will be described with reference to FIGS. 16 and 17. The inner shell 130 may be seated on the middle tray 400. The inner shell 130 may be disposed on the upper side of the middle tray 400. The shell support 134 of the inner shell 130 may be seated on the middle tray 400. The shell support 134 may contact the middle tray 400 and support the inner shell 130.

The shell injection hole 1302 of the inner shell 130 may be formed in the center of the lower surface of the inner shell 130. The middle injection hole 4002 of the middle tray 400 may be formed in the center of the middle plate. The shell injection hole 1302 may correspond to the middle injection hole 4002. In other words, the inner shell 130 may be arranged vertically on the middle tray 400 so that a central axis of the shell injection hole 1302 and a central axis of the middle injection hole 4002 are aligned with each other.

The shell inlet 1304 of the inner shell 130 may be located on or at one (first) side of the shell injection hole 1302. That is, the shell inlet 1304 may be radially separated from shell injection hole 1302.

The shell support 134 may be located on the other (second) side of the shell injection hole 1302. A plurality of shell supports 134 may be separated in the radial direction from the shell injection hole 1302.

A plurality of shell supports 134 and the shell inlet 1304 may be arranged along the periphery of the shell injection hole 1302. In other words, the plurality of shell supports 134 and the shell inlet 1304 may be separated in the radial direction from the periphery of the shell injection hole 1302 and arranged along the periphery of the shell injection hole 1302.

The middle outlet 4004 of the middle tray 400 may be located on or at one side of the middle injection hole 4002. That is the middle outlet 4004 may be separated in the radial direction from the middle injection hole 4002.

When the inner shell 130 is disposed on the upper side of the middle tray 400, the shell injection hole 1302 may be disposed to correspond to the position of the middle injection hole 4002, and the shell inlet 1304 may be disposed to correspond to the position of the middle outlet 4004. In other words, the user may couple the inner shell 130 to the middle tray 400 so that the position of the middle outlet 4004 and the position of the shell inlet 1304 are aligned in the vertical direction. With this structure, it is possible to guide the assembly to the user.

When the humidified air generated in the humidifying device 200 is discharged through the humidified air outlet 2742, the humidified air may flow into an interior of the inner shell 130 through the shell inlet 1304. The first discharge flow path 1000a through which humidified air flows may be formed inside of the inner shell 130. The second discharge flow path 1000b may be formed outside of the inner shell 130.

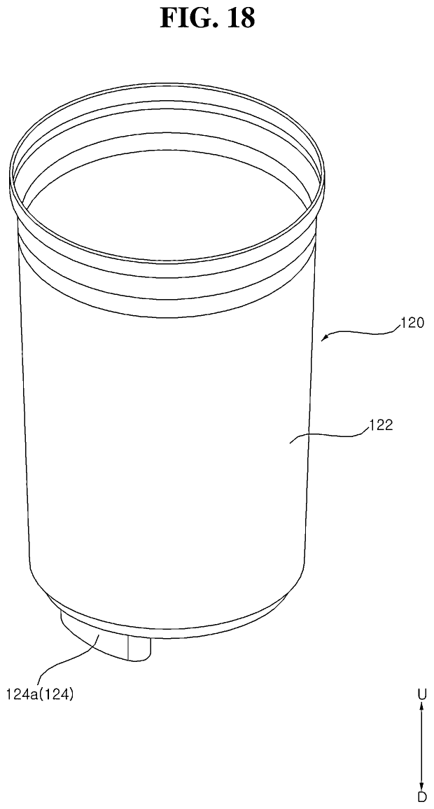

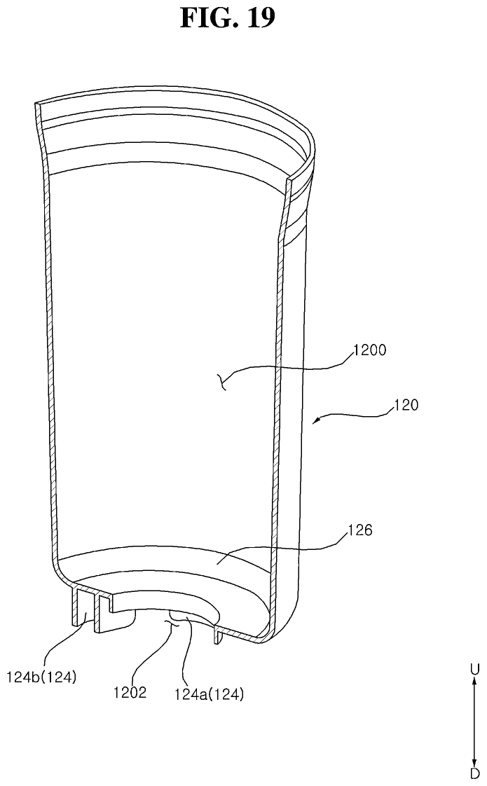

The water tank housing 120 will be described with reference to FIGS. 18 to 20. The water tank housing 120 may accommodate the water tank 110. The water tank housing 120 may have an internal space 1200 in which the water tank 110 is disposed. The water tank housing 120 may surround the water tank 110. The water tank housing 120 may be a holder for the water tank 110. The water tank housing 120 may cover a water tank peripheral wall 112 of the water tank 110. The water tank 110 may be fitted into the water tank housing 120. The water tank peripheral wall 112 may be in close contact with an inner peripheral wall of the water tank housing 120. The water tank housing 120 may fix the inserted water tank 110 to prevent it from moving in the horizontal direction. The water tank housing 120 may remain level so that the water tank 110 does not tip over inside of the case 10. Each of the water tank housing 120 and the water tank 110 may be separated from the case 10. The water tank housing 120 may include the housing peripheral wall 122 that partitions the internal space.

The water tank housing 120 may include the housing support 124. The housing support 124 may extend downward from the water tank housing 120. The housing support 124 may be formed on a lower surface of the water tank housing 120. The housing support 124 may extend downward from the lower surface of the water tank housing 120. The housing support 124 may support the water tank housing 120. The housing support 124 may transfer a load of the water tank housing 120 downward.

The water tank housing 120 may include the insertion space 1200 in which the water tank 110 is accommodated. The insertion space 1200 may be formed inside of the water tank housing 120. The insertion space 1200 may be partitioned by the housing peripheral wall 122.

The injector 114 may penetrate the lower surface of the water tank housing 120. The injector 114 may protrude from the lower surface of the water tank housing 120. The injector 114 may be mounted on the supply pipe 210 of the humidifying device 200.

A housing injection hole 1202 may be a through hole formed in the water tank housing 120. The injector 114 may be disposed in the housing injection hole 1202. The injector 114 may protrude downward from the water tank housing 120 through the housing injection hole 1202. The injector 114 that protrudes downward may be mounted on the supply pipe 210 of the humidifying device 200.

The housing support 124 may include the first housing support 124a and the second housing support 124b. The first housing support 124a may protrude from the water tank housing 120. The first housing support 124a may extend from the lower surface of the water tank housing 120. For example, the first housing support 124a may extend downward from the lower surface of the water tank housing 120. The first housing support 124a may support the water tank housing 120. The first housing support 124a may transfer the load of the water tank housing 120 and/or the water tank 110 downward. The first housing support 124a may extend in the peripheral direction of the water tank housing 120. There may be a plurality of first housing supports 124a. The plurality of first housing supports 124a may be separated from each other on the lower surface of the water tank housing 120. A plurality of first housing supports 124a may be disposed on the lower surface of the water tank housing 120 in the peripheral direction. A plurality of first housing supports 124a may be disposed in the radial direction on the lower surface of the water tank housing 120. For example, a pair of first housing supports 124a may extend downward from the lower surface of the water tank housing 120, and the pair of first housing supports 124a may be separated radially in the opposite direction with respect to a center of the lower surface of the water tank housing 120.

The second housing support 124b may protrude from the water tank housing 120. The second housing support 124b may extend from the lower surface of the water tank housing 120. For example, the second housing support 124b may extend downward from the lower surface of the water tank housing 120. The second housing support 124b may support the water tank housing 120. The second housing support 124b may transfer the load of the water tank housing 120 and/or the water tank 110 downward. The second housing support 124b may extend in the peripheral direction of the water tank housing 120. The second housing support 124b may prevent the water tank housing 120 from tipping over. The second housing support 124b may be located between the plurality of first housing supports 124a. For example, one pair of first housing supports 124a may be separated in a first radial direction and in the opposite direction of the first radial direction with respect to the center of the lower surface of the water tank housing 120, and the second housing support 124b may be located in a second radial direction orthogonal to the first radial direction. In other words, the second housing support 124b may be located between the pair of first housing supports 124a.

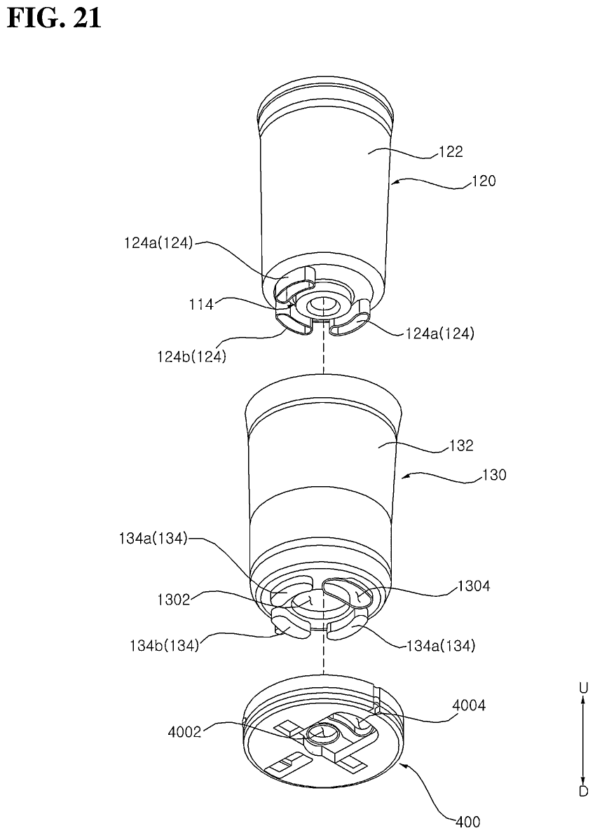

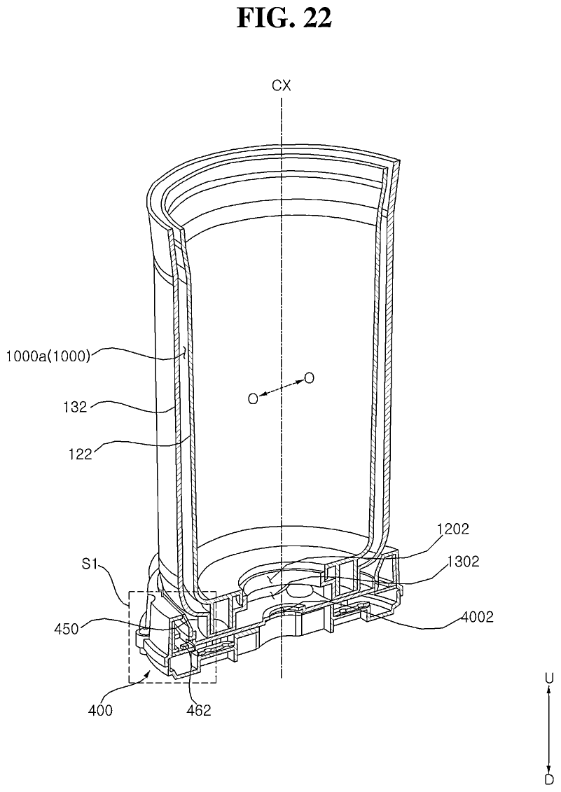

An assembly process for the water tank housing, the inner shell 130, and the middle tray will be described with reference to FIGS. 21 to 23. The inner shell 130 may accommodate the water tank housing 120. The inner shell 130 may have the opening in the upper side thereof. The water tank housing 120 may be inserted into the open upper side of the inner shell 130. The water tank housing 120 may be inserted into the open upper side of the inner shell 130 and mounted therein. The position of the housing support 124 may correspond to the position of the shell support 134. For example, the positions of a pair of first housing supports 124a may be aligned in the vertical direction to correspond to the positions of a pair of first shell supports 134a. Also, the position of the second housing support 124b may be aligned in the vertical direction to correspond to the position of the second shell support 134b. The housing support 124 may transfer the load to the shell support 134. The shell support 134 may transfer the load to the load sensor 480 of the middle tray 400.

The inner shell 130 may be seated on the upper side of the middle housing 410. The water tank 110, the water tank housing 120, and/or the inner shell 130 may be disposed on the upper side of the middle tray 400. The water tank 110 and/or the water tank housing 120 may be accommodated in the inner shell 130.

The inner shell 130 may be separated outward from the water tank housing 120. The first discharge flow path 1000a may be formed between the inner shell 130 and the water tank housing 120. The water tank 110 may be accommodated in the water tank housing 120. The water tank 110 may be in close contact with the inside of the water tank housing 120.

The housing injection hole 1202 may be connected to the shell injection hole 1302. The shell injection hole 1302 may be connected to the middle injection hole 4002. The housing injection hole 1202, the shell injection hole 1302, and the middle injection hole 4002 may form an injection space. The injector 114 may be disposed in the injection space. The supply pipe 210 of the humidifying device 200 may protrude upward through the middle injection hole 4002. The injector 114 may be mounted on the supply pipe 210.

The light diffuser 450 may face the inner shell 130. For example, the light diffuser 450 may face the lower portion of the inner shell 130. The light source 462 may be disposed below the light diffuser 450. The light diffuser 450 may diffuse the light emitted from the light source 462. The light diffuser 450 may diffuse the light emitted from the light source 462 and direct the diffused light to the first discharge flow path 1000a. The inner shell 130 may be made of a light-transmissive material. For example, the inner shell 130 may be transparent so that the first discharge flow path 1000a formed inside is visible from the outside. Light diffused by the light diffuser 450 may pass through the transparent inner shell 130 and spread to the first discharge flow path 1000a. Light may illuminate humidified air flowing through the first discharge flow path 1000a. The user may visually check the humidified air flowing through the first discharge flow path 1000a through the transparent inner shell 130.

The light source 462 may be mounted on the lighting plate 464. The light source 462 may be disposed below the light diffuser 450. A horizontal position of the light source 462 may be located between horizontal positions of the upper end and the lower end of the light diffuser 450. The light source 462 may be located inside of the middle cover 430 in the horizontal direction. For example, the light source 462 may be located in inside of the middle cover 430 in the horizontal direction. The light source 462 may be separated upward from the middle base 440. The light source 462 may be separated from the light diffuser 450. The light diffuser 450 may be separated upward from the light source 462. For example, the light diffuser may be separated upward from the light source by a predetermined height H1.

The lighting plate 464 may be disposed between the middle cover 430 and the middle plate 420. The lighting plate 464 may be separated upward from the middle base 440.

A lighting bracket 466 may fix the lighting plate 464. The lighting bracket 466 may be connected to the middle cover 430. The lighting bracket 466 may fix the lighting plate 464 to the middle cover 430. Through the lighting bracket 466, the lighting substrate 464 may be separated upward from the middle base 440.

The first housing support 124a of the water tank housing 120 may apply pressure to the first shell support 134a. The first housing support 124a may be located inside of the first shell support 134a. The first housing support 124a may transfer the load of the water tank 110 and the water tank housing 120 to the first shell support 134a. The first shell support 134a may apply pressure to the load sensor 480. The first shell support 134a may contact the contact plate 482. The first shell support 134a exerts pressure on the contact plate 482, causing the contact plate 482 to be lowered.

A presser 484 may extend downward from the contact plate 482. The presser 484 may transfer the load pressed on the contact plate 482 to a sensor plate 486. The presser 484 may penetrate the middle plate 420 and contact the sensor plate 486 disposed inside of the middle housing 410.

The middle tray 400 may include a recess 422 in which the load sensor 480 is disposed. The recess 422 may be formed in the middle plate 420. The contact plate 482 may be disposed in the recess 422. The contact plate 482 disposed in the recess 422 may move in the vertical direction. A shape of the recess 422 may correspond to A shape of the contact plate 482. The recess 422 may be formed with a through hole into which the presser 484 is inserted.

The sensor plate 486 may measure a displacement of the contact plate. The sensor plate 486 may convert the displacement of the presser 484 into an electrical signal. The sensor plate 486 may detect a load by measuring the electrical signal. The sensor plate 486 may detect a level of water stored in the water tank 110 based on the load.

The middle plate 420 may include a sensor stopper 424 that limits a movement range of the contact plate 482. The sensor stopper 424 may be located below the contact plate 482. The sensor stopper 424 may protrude upward from the recess 422. The sensor stopper 424 may extend along a periphery of the through hole formed in the recess 422. The sensor stopper 424 may be formed so that the periphery of the through hole formed in the recess 422 protrudes upward. The sensor stopper 424 may prevent the contact plate 482 from moving downward beyond a predetermined displacement. When the contact plate 482 moves downward beyond the predetermined displacement, the sensor stopper 424 contacts a lower surface of the contact plate 482, and the contact plate 482 may no longer move downward.

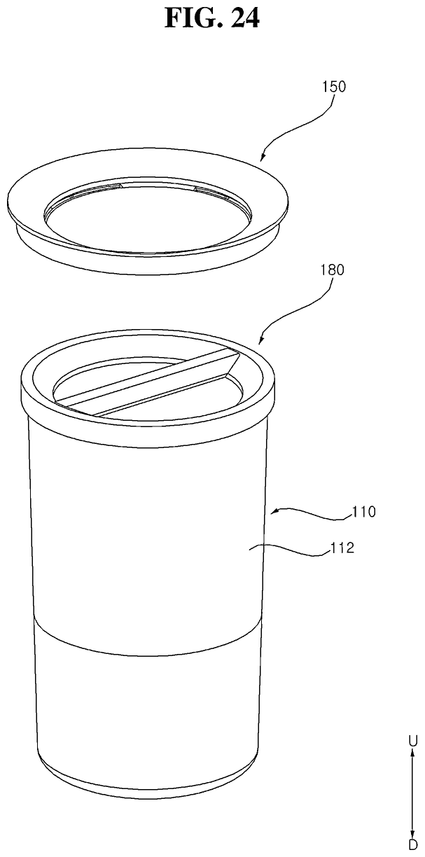

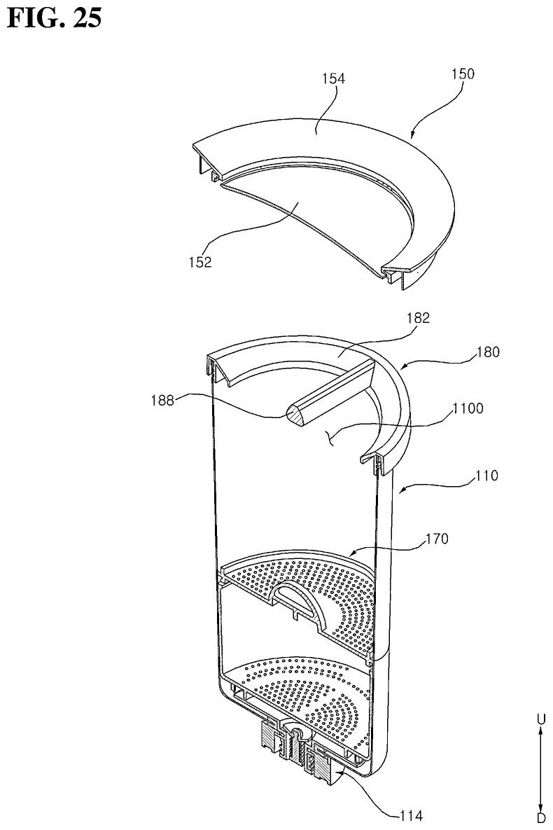

The water tank 110 and the water tank cover 150 will be described with reference to FIGS. 24 and 25. The water tank 110 may be formed in a cylindrical shape, for example. The water tank 110 may extend in the vertical direction. The water tank 110 may have the water storage space 1100 formed therein. The water tank 110 may include the water tank peripheral wall 112 that forms the external appearance. The water tank peripheral wall 112 may partition the water storage space 1100 of the water tank 110.

A water tank handle 180 may be fastened to the water tank 110. The water tank handle 180 may be rotated and fastened to the water tank 110. The water tank 110 may be formed with a fastening protrusion unit 115 to which the water tank handle 180 is fastened. The fastening protrusion unit 115 may protrude outward from an outer surface of the water tank 110. Alternatively, the fastening protrusion unit 115 may protrude inward from an inner surface of the water tank 110.

The water tank handle 180 may include a handle rim 182 coupled to an upper end of the water tank 110. The handle rim 182 may extend along a periphery of the upper end of the water tank 110. The handle rim 182 may be formed in an annular shape, for example.

The water tank handle 180 may include a handle bar 188. The user may hold the handle bar 188 to move the water tank 110. For example, the user may separate the water tank 110 from the case 10 by holding the handle bar 188 and pulling upward. Also, the user may hold the handle bar 188 and insert the water tank 110 into the case 10. The handle bar 188 may be formed in a straight-line shape, for example. The handle bar 188 may be coupled to the handle rim 182. The handle bar 188 may extend in the radial direction from the handle rim 182.

The water tank cover 150 may cover the open upper side of the water tank 110. The water tank cover 150 may open or close the water tank 110. The water tank cover 150 may be disposed inside of the discharge grill 160. The water tank cover 150 may be disposed at the center of the annular discharge grill 160. For example, the water tank 110 may be disposed at the center of the shells 130, 140, and the water tank cover 150 may cover the open upper side of the water tank 110.

A guide rim 154 may form a periphery of the water tank cover 150. In other words, the guide rim 154 may form an edge of the water tank cover 150. The guide rim 154 may be formed in an annular shape with an opening in the center thereof.

A guide cover 152 may be disposed inside of the guide rim 154. The guide cover 152 may be disposed at a center of the guide rim 154. For example, the guide cover 152 may be disposed in the open center of the guide rim 154. The guide cover 152 may be formed in a circular shape, for example. For example, the guide cover 152 may have a circular plate shape.

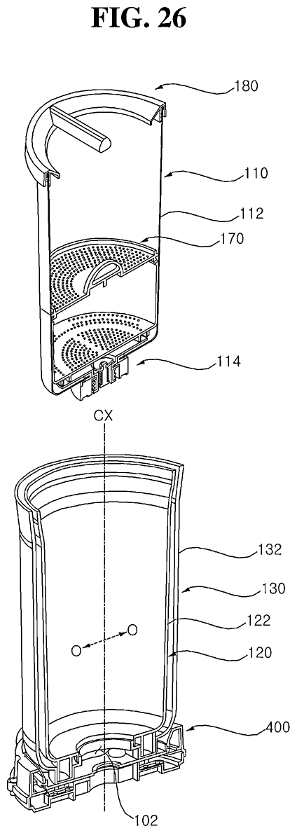

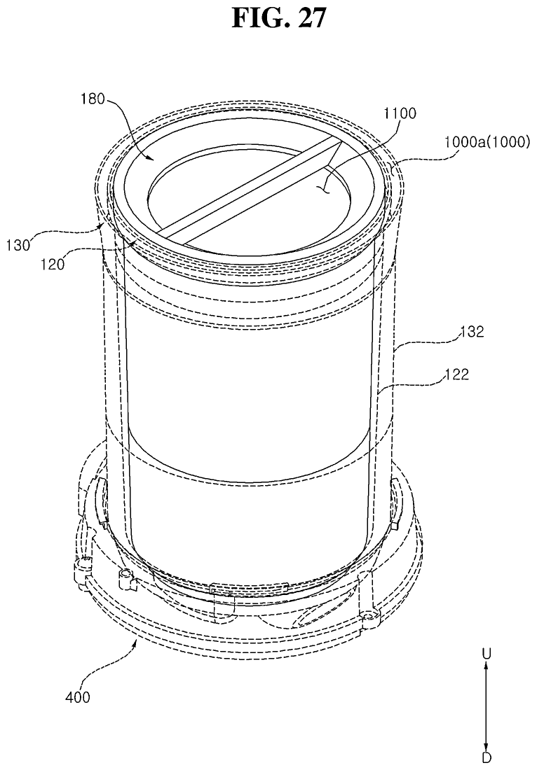

an assembly process for the water tank 110 will be described with reference to FIGS. 26 and 27. Water stored in the water storage space 1100 may be supplied to the humidifying device 200 through the injector 114. The injector 114 may be mounted on the lower side of the water tank 110. The injector 114 may be placed in the housing injection hole (unmarked) of the water tank housing 120. The injector 114 may be disposed at the shell injection hole 1302 of the inner shell 130. The housing injection hole (unmarked) and the shell injection hole 1302 may form the injection space 102. The injector 114 may be disposed in injection space 102. Water stored in the water storage space 1100 may be injected into the supply pipe 210 through the injector 114.

The water tank 110, the water tank housing 120, and/or the inner shell 130 may be disposed on the upper side of the middle tray 400. The water tank 110 and/or the water tank housing 120 may be accommodated in the inner shell 130.

The inner shell 130 may be separated outward from the water tank housing 120. A diameter of the inner shell 130 may be larger than a diameter of the water tank housing 120. A separation gap may be formed between the inner shell 130 and the water tank housing 120. The discharge flow path 1000 may be formed between the inner peripheral wall 132 and the housing peripheral wall 122. For example, the first discharge flow path 1000a through which humidified air flows may be formed between the inner peripheral wall 132 and the housing peripheral wall 122.

The lower surface of the inner shell 130 may be separated outward from the lower surface of the water tank housing 120. The lower surface of the inner shell 130 may be separated downward from the lower surface of the water tank housing 120. A separation gap may be formed between the lower surface of the inner shell 130 and the lower surface of the water tank housing 120. The discharge flow path 1000 may be formed between the lower surface of the inner shell 130 and the lower surface of the water tank housing 120. For example, the first discharge flow path 1000a through which humidified air flows may be formed between the inner peripheral wall 132 and the housing peripheral wall 122.

Humidified air generated from the humidifying device 200 may be discharged through the humidified air outlet 2742, and the discharged humidified air may be introduced into the inner shell 130 through the shell inlet 1304. The introduced humidified air may flow through the first discharge flow path 1000a formed inside of the inner shell 130.

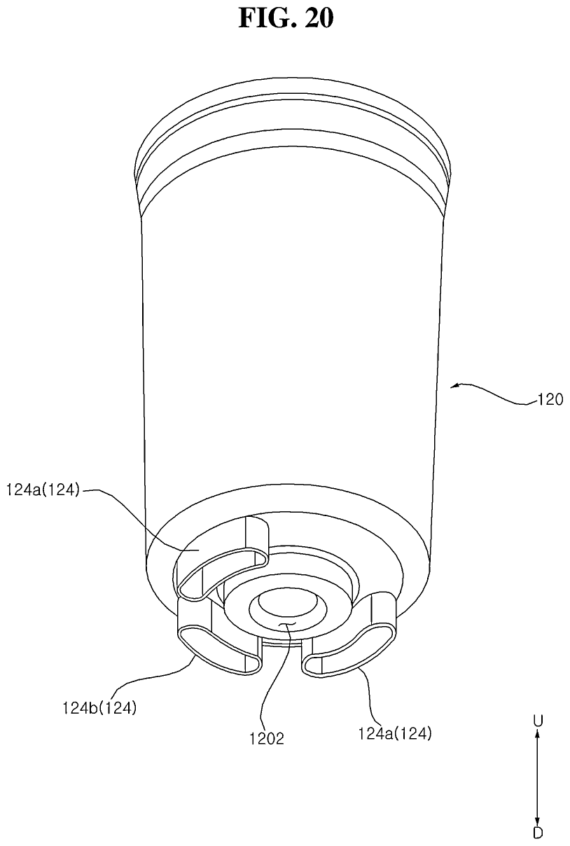

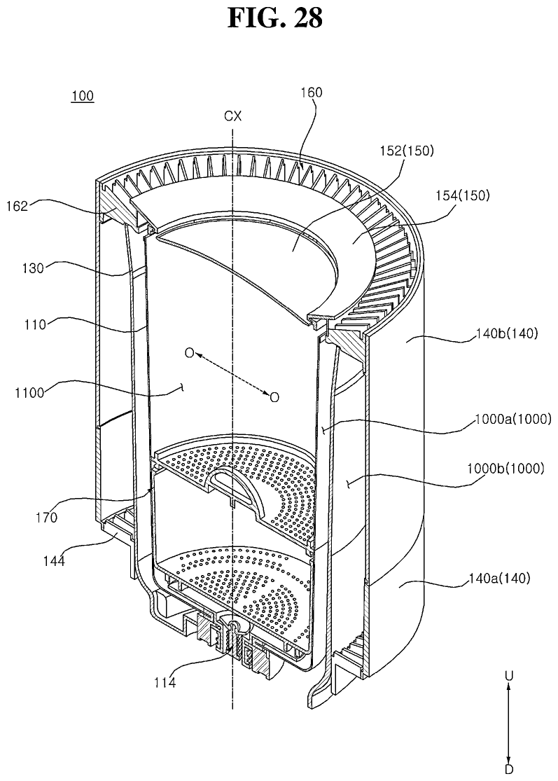

The discharge flow path 1000 formed inside of the flow path unit 100 will be described with reference to FIGS. 28 and 20. The flow path unit 100 may include the water tank 110, an ion exchange resin 170, the inner shell 130, the outer shell 140, the discharge grill 160, the water tank cover 150, and the discharge flow path 1000.

the water storage space 1100 may be formed inside of the water tank 110. The water storage space 1100 of the water tank 110 may be located at the center of the case 10. The storage space 1100 may extend in the vertical direction. The storage space 1100 may be open upward. The water tank cover 150 may cover the open upper side of the water storage space 1100. The guide rim 154 may be located at the upper end of the water tank 110. The guide rim 154 may be disposed above the upper end of the water tank 110. The guide cover 152 may be located at the upper side of the water storage space 1100. The guide cover 152 may cover the open upper side of the water storage space 1100.

The ion exchange resin 170 may be disposed inside of the water tank 110. The ion exchange resin 170 may be disposed in the water storage space 1100. The ion exchange resin 170 may change a composition of water stored in the water storage space 1100. The ion exchange resin 170 may exchange ions with water stored in the water storage space 1100. The ion exchange resin 170 may selectively remove or replenish some ions contained in the water stored in the water storage space 1100. The ion exchange resin 170 may include a cation exchange resin and an anion exchange resin. The cation exchange resin may absorb cations contained in water stored in the water storage space 1100. The cation exchange resin may release positive ions into the water stored in the water storage space 1100. The anion exchange resin may absorb anions contained in water stored in the water storage space 1100. The anion exchange resin may allow water stored in the water storage space 1100 to emit negative ions.

The inner shell 130 may be located outside of the water tank 110. The discharge flow path 1000 may be formed between the inner shell 130 and the water tank 110. The discharge flow path 1000 may be formed between the inner peripheral wall 132 and the water tank peripheral wall 112. The discharge flow path 1000 may be formed between the lower surface of the inner shell 130 and the lower surface of the water tank housing 120. For example, the first discharge flow path 1000a may be formed between the inner shell 130 and the water tank 110. The first discharge passage 1000a may be formed outside of the water storage space 1100. The first discharge passage 1000a may be connected to the discharge flow path 2740 of the humidifying device 200.

The outer shell 140 may be located outside of the inner shell 130. The discharge flow path 1000 may be formed between the outer shell 140 and the inner shell 130. The discharge flow path 1000 may be formed between the outer peripheral wall 142 and the inner peripheral wall 132. For example, a second discharge flow path 1000b may be formed between the outer shell 140 and the inner shell 130. The second discharge flow path 1000b may be formed outside of the first discharge flow path 1000a. The second discharge flow path 1000b may be connected to the blower flow path 390.

The outlet 1600 may be formed at one end of the discharge flow path 1000. The first outlet 1600a may be formed at one end of the first discharge flow path 1000a. The second outlet 1600b may be formed at one end of the second discharge flow path 1000b. One end of the first discharge flow path 1000a and one end of the second discharge flow path 1000b may be joined to form the outlet 1600.

The discharge grill 160 may be disposed at the outlet 1600. The discharge grill 160 may be disposed between the inner shell 130 and the outer shell 140. The discharge grill 160 may be disposed outside of the water tank cover 150. The discharge grill 160 may extend in an annular shape along the inner periphery of the upper end of the outer shell 140. The discharge grill 160 may extend in an annular shape along the outer periphery of the upper end of the inner shell 130. The discharge grill 160 may include a plurality of discharge vanes 162. The plurality of discharge vanes 162 may be disposed along the inner periphery of the upper end of the outer shell 140. The discharge vane 162 may extend in the vertical direction. The plurality of discharge vanes 162 may be separated from each other in the radial direction. The plurality of discharge vanes 162 may be separated from each other along the periphery of the outlet 1600.

The water tank cover 150 may be seated on the discharge grill 160. The water tank cover 150 may be detachably coupled to the upper side of the discharge grill 160.

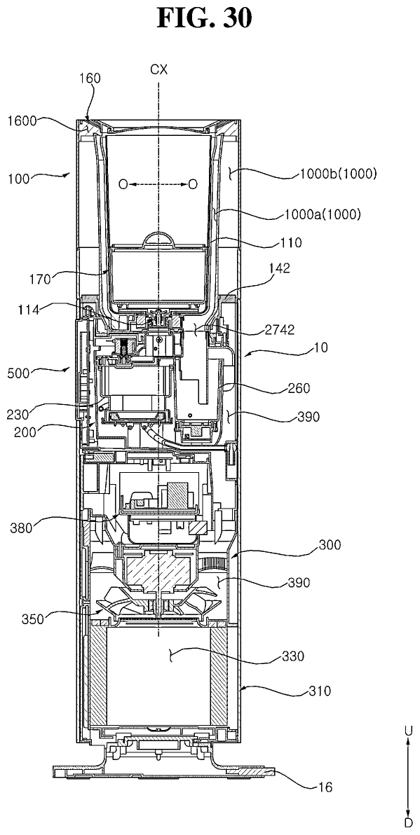

An entire flow of the humidifier 1 will be described with reference to FIG. 30. The blower 300 may form an airflow. The blower 300 may be disposed inside of the case 10. The blower 300 may form an airflow inside of the case 10. The blower 300 may introduce indoor air into the case 10 through the inlet 310. The blower device 300 may direct drawn air to the humidifying device 200 and/or the flow path unit 100. The blower 300 may form an airflow that pulls the humidified air generated by the humidifier 200. The blower 300 may provide power to discharge the humidified air generated by the humidifying device 200 into the indoor space.

The humidifying device 200 may generate humidified air. The humidifying device 200 may be disposed inside of the case 10. The humidifying device 200 may be disposed above the blower 300. The humidifying device 200 may discharge humidified air. The rising airflow formed by the blower 300 may be directed to the humidifying device 200 through the blower flow path 390. The rising airflow may pull the humidified air generated by the humidifying device 200 upward. Humidified air may be discharged through the outlet 1600 along with the rising airflow.

The flow path unit 100 may include a flow path through which air is discharged. The flow path unit 100 may include the discharge flow path 1000. The discharge flow path 1000 may include the first discharge flow path 1000a and the second discharge flow path 1000b. Humidified air generated by the humidifying device 200 may flow to the first outlet 1600a through the first discharge flow path 1000a. Humidified air may be supplied to the indoor space through the first outlet 1600a. A portion of the air flowing through the blower flow path 390 may flow to the second outlet 1600b through the second discharge flow path 1000b. The portion of the air may be supplied to the indoor space through the second outlet 1600b.

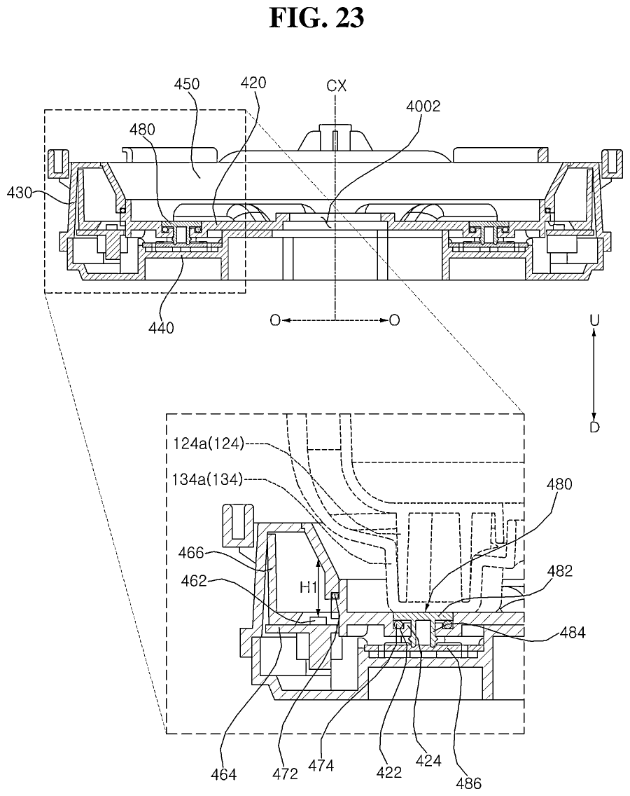

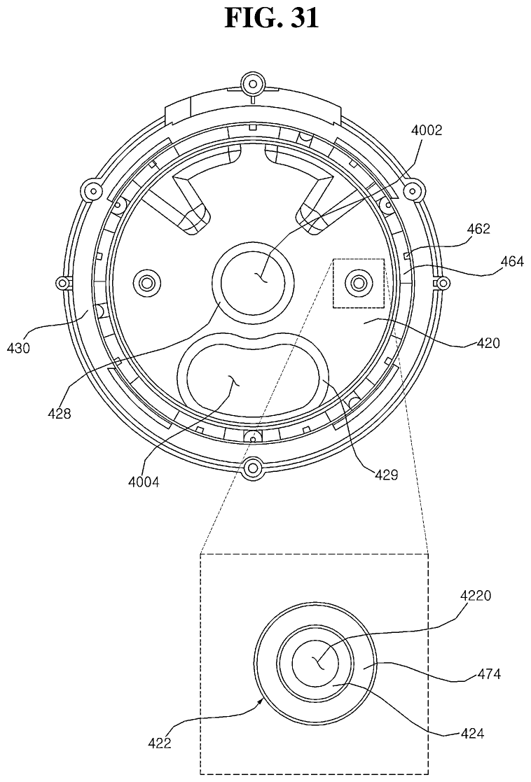

Referring to FIGS. 23 and 31, the load sensor 480 may include the contact plate 482, the presser 484, and the sensor plate 486. The first housing support 124a of the water tank housing 120 may apply pressure to the first shell support 134a. The first housing support 124a may be located inside of the first shell support 134a. The first housing support 124a may transfer the load of the water tank 110 and the water tank housing 120 to the first shell support 134a. The first shell support 134a may apply pressure to the load sensor 480. The first shell support 134a may contact the contact plate 482. The first shell support 134a exerts pressure on the contact plate 482, causing the contact plate 482 to be lowered.

The presser 484 may extend downward from the contact plate 482. The presser 484 may transfer the load pressed on the contact plate 482 to the sensor plate 486. The presser 484 may penetrate the middle plate 420 and contact the sensor plate 486 disposed inside of the middle housing 410.

The middle tray 400 may include the recess 422 in which the load sensor 480 is disposed. The recess 422 may be formed in the middle plate 420. The contact plate 482 may be disposed in the recess 422. The contact plate 482 disposed in the recess 422 may move in the vertical direction. The shape of the recess 422 may correspond to the shape of the contact plate 482. The recess 422 may be formed with a through hole into which the presser 484 is inserted.

The sensor plate 486 may measure the displacement of the contact plate 482. The sensor plate 486 may convert the displacement of the presser 484 into an electrical signal. The sensor plate 486 may detect a load by measuring the electrical signal. The sensor plate 486 may detect the level of water stored in the water tank 110 based on the load.

The middle plate 420 may include the sensor stopper 424 that limits the movement range of the contact plate 482. The sensor stopper 424 may be located below the contact plate 482. The sensor stopper 424 may protrude upward from the recess 422. The sensor stopper 424 may extend along the periphery of the through hole formed in the recess 422. The sensor stopper 424 may be formed so that the periphery of the through hole formed in the recess 422 protrudes upward. The sensor stopper 424 may prevent the contact plate 482 from moving downward beyond a predetermined displacement. When the contact plate 482 moves downward beyond the predetermined displacement, the sensor stopper 424 contacts the lower surface of the contact plate 482, and the contact plate 482 may no longer move downward.

Referring to FIGS. 23 and 31, the middle tray 400 may include a sealer 470. The sealer 470 may include a first sealer 472 disposed between the light diffuser 450 and the middle housing 410. The first sealer 472 may be disposed below the light diffuser 450. The first sealer 472 may be disposed on the upper side of the middle plate 420. The first sealer 472 may be disposed outside of the periphery of the middle plate 420. The first sealer 472 may extend in the peripheral direction of the middle plate 420. The first sealer 472 may be formed in an annular shape, for example. The first sealer 472 may be in close contact with the light diffuser 450. The first sealer 472 may be in close contact with the middle plate 420. A cross-section of the first sealer 472 may have a circular shape, for example.

The sealer 470 may include a second sealer 474 disposed below the load sensor 480. The second sealer 474 may be disposed between the load sensor 480 and the middle plate 420. The second sealer 474 may be disposed in the recess 422. The second sealer 474 may be disposed outside of the sensor stopper 424. For example, the second sealer 474 may be disposed between the sensor stopper 424 and the peripheral wall forming the recess 422. The second sealer 474 may separate the contact plate 482 upward from the sensor stopper 424. The second sealer 474 may buffer the load transferred from the upper side. The second sealer 474 may be in close contact with the contact plate 482. The second sealer 474 may be in close contact with the recess 422. As the load transferred to the contact plate 482 increases, the second sealer 474 may move closer to the contact plate 482 and the recess 422. The second sealer 474 may extend along the periphery of the recess 422. The second sealer 474 may be formed in an annular shape, for example. The second sealer 474 may have a circular cross-section, for example. A cross-sectional diameter of the second sealer 474 may be smaller than a horizontal gap between the sensor stopper 424 and the peripheral wall forming the recess 422. Accordingly, when the second sealer 474 is compressed by the load, the second sealer 474 may be compressed in the vertical direction and stretched in the horizontal direction.

Referring to FIG. 31, the middle plate 420 may include the middle outlet 4004 and a discharge rib 429. The middle plate 420 may include the middle outlet 4004 through which humidified air passes. The middle outlet 4004 may be formed on one side of the middle plate 420. The middle outlet 4004 may be a through hole formed in the middle plate 420. The shape of the middle outlet 4004 may correspond to the shape of the humidified air outlet 2742. The shell inlet 1304 of the inner shell 130 may be connected to the middle outlet 4004. The protruding edge 138 of the inner shell 130 may correspond to the periphery forming the middle outlet 4004.

The discharge rib 429 may protrude from the middle plate 420. The discharge rib 429 may form the middle outlet 4004. The discharge rib 429 may be a boundary forming the middle outlet 4004. The discharge rib 429 may extend upward from a periphery of the middle outlet 4004. A height at which the discharge rib 429 protrudes from the middle plate 420 may correspond to a height at which the injection rib 428 protrudes from the middle plate 420.

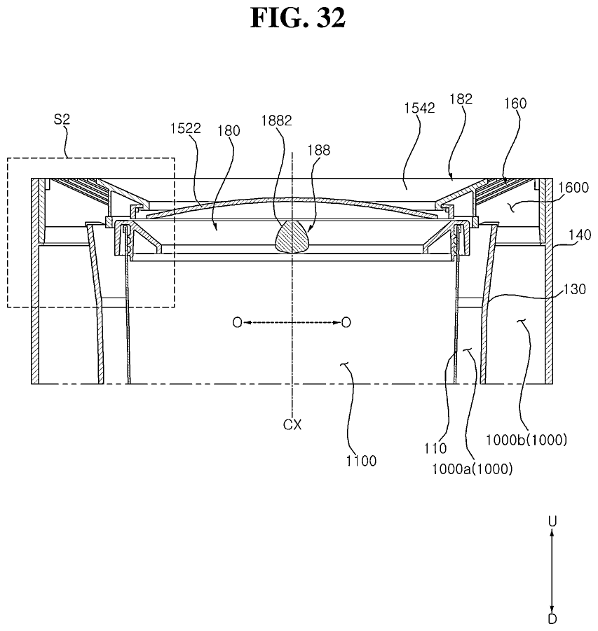

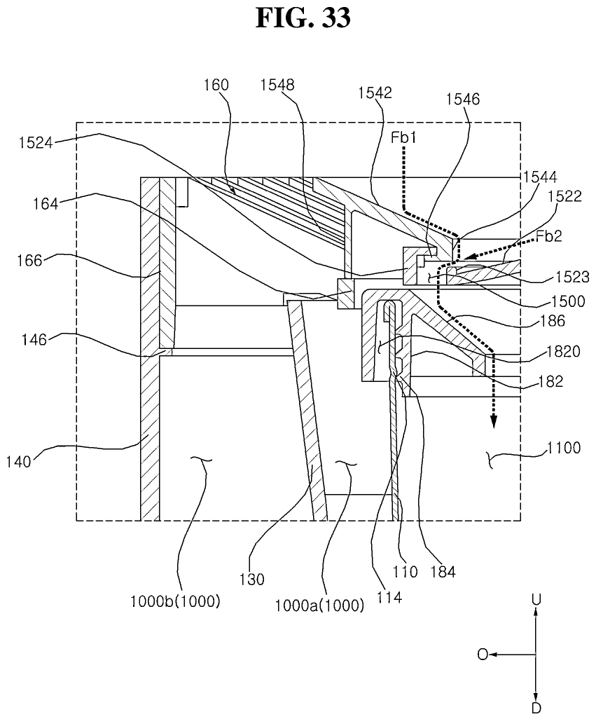

Referring to FIGS. 32 and 33, a supply hole 1500 may be located in the upper side of the water storage space 1100. A guide plate 1522 may cover the open upper side of the water storage space 1100. an outer periphery of the guide plate 1522 may extend along the peripheral direction of the upper end of the water tank 110. A diameter of the guide plate 1522 may be smaller than the diameter of the water tank 110. The guide plate 1522 may be located above the water tank 110. The guide plate 1522 may be located above the upper end of the water tank 110. For example, the outer periphery of the guide plate 1522 may be located above the upper end of the water tank 110. The guide plate 1522 may be separated inward from the upper end of the water tank 110. For example, the outer periphery of the guide plate 1522 may be separated inward in the horizontal direction from the periphery of the upper end of the water tank 110.

A boundary wall 1524 of the guide cover 152 may be separated outward from the guide plate 1522. The boundary wall 1524 may extend along a periphery of the guide plate 1522. A diameter of the boundary wall 1524 may be larger than the diameter of the guide plate 1522. The water supply hole 1500 may be formed between the boundary wall 1524 and the guide plate 1522. The boundary wall 1524 may be located above the water tank 110. The boundary wall 1524 may be located above the upper end of the water tank 110. The boundary wall 1524 may be located inside of the upper end of the water tank 110. For example, the inner surface of the boundary wall 1524 may be separated inward from the periphery of the upper end of the water tank 110 in the horizontal direction.

The water supply hole 1500 may be formed between the guide rim 154 and the guide cover 152. The water supply hole 1500 may be formed between the boundary wall 1524 and the guide plate 1522. The water supply hole 1500 may be located above the water storage space 1100. The water supply hole 1500 may be adjacent to the upper end of the water tank 110. The water supply hole 1500 may be located inside of the upper end of the water tank 110. For example, the water supply hole 1500 may be located inside of the upper end of the water tank 110 in the horizontal direction. The inside may refer to the center direction or the direction opposite to the radial direction of the water tank 110. The water supply hole 1500 may extend along the peripheral direction of the upper end of the water tank 110. There may be a plurality of water supply holes 1500. The plurality of water supply holes 1500 may be separated from each other along the periphery of the guide cover 152.

The discharge grill 160 may be coupled to the case 10. The case 10 may include a protruding rib 147 on which the discharge grill 160 is seated. The protruding rib 147 may protrude inward from the inner wall of the case 10. The protruding rib 147 may protrude inward from the inner wall of the outer shell 140. The discharge grill 160 may be seated on the protruding rib 147. The discharge grill may include an outer wall 166 forming an outer periphery. The outer wall 166 may be seated on the protruding rib 147. The discharge grill 160 may include an inner rim 164 forming an inner periphery. The inner rim 164 may be separated inward from the outer wall 166. A discharge vane 162 may be disposed between the outer wall 166 and the inner rim 164. The outer wall 166 and the inner rim 164 may be formed in an annular shape, for example. A plurality of discharge vanes 162 may be separated from each other between the outer wall 166 and the inner rim 164. The discharge vane 162 may be separated upward from the inner shell 130. The discharge vane 162 may not contact the inner shell 130. For example, a plurality of discharge vanes 162 may be separated upward from the upper end of the inner shell 130. Accordingly, a load of the discharge grill 160 may not be transferred to the inner shell 130.

The water tank cover 150 may be disposed on the upper side of the discharge grill 160. The guide rim 154 may be seated on the inner rim 164 of the discharge grill 160. For example, a support peripheral wall 1548 of the guide rim 154 may be seated on the inner rim 164 of the discharge grill 160. The guide rim 154 may be separated upward from the upper end of the water tank 110. The guide rim 154 may be separated upward from the water tank handle 180. Accordingly, the water tank cover 150 may not contact the water tank 110. The water tank cover 150 may not transfer the load to the water tank 110.

An inner peripheral wall 1544 of the guide rim 154 may be located inside of the outer periphery of the guide plate 1522. For example, the inner peripheral wall 1544 of the guide rim 154 may be separated farther inward in the horizontal direction than the outer periphery of the guide plate 1522. The inner peripheral wall 1544 of the guide rim 154 may be located above the guide plate 1522. The inner peripheral wall 1544 of the guide rim 154 may be separated upward from the upper surface of the guide plate 1522. Water supplied to the guide cover 152 may flow to the edge along the inclined upper surface of the guide plate 1522. The supplied water may flow toward the water supply hole 1500 through the gap between the inner peripheral wall 1544 and the guide plate 1522. Water passing through the water supply hole 1500 may fall into the storage space 1100. Water passing through the water supply hole 1500 may flow downward along the water tank peripheral wall 112. The boundary wall 1524 may prevent water passing through the water supply hole 1500 from flowing over to the outside of the water tank 110.

Referring to FIGS. 32 and 33, the humidifier 1 may include a second guide slope 186. The second guide slope 186 may be inclined downward in an inward direction. The second guide slope 186 may extend downward in the center direction. The second guide slope 186 may be located inside of a first guide slope 1542. The second guide slope 186 may be located lower than the first guide slope 1542. The second guide slope 186 may be located below the water supply hole 1500. an upper end of the second guide slope 186 may be located outside of the water supply hole 1500. For example, the upper end of the second guide slope 186 may be located outside of an inner surface of the boundary wall 1524 in the horizontal direction. A lower end of the second guide slope 186 may be located inside of the water supply hole 1500. For example, the lower end of the second guide slope 186 may be located inside of the outer periphery of the guide plate 1522 in the horizontal direction. The supplied water may pass through the water supply hole 1500 and fall into the storage space 1100 along the second guide slope 186.

The handle rim 182 may include a fastening space 1820 into which the upper end of the water tank 110 is inserted. The fastening space 1820 may be formed inside of the handle rim 182. The handle rim 182 may include a fastening protrusion 184 corresponding to the fastening protrusion unit 115. The fastening protrusion 184 may protrude from the handle rim 182 toward the fastening space 1820. The fastening protrusion 184 may rotate along the fastening protrusion unit 115 and fastens to each other.

The handle bar 188 may have a handle slope 1882 that inclines downward. The handle slope 1882 may form one surface of the handle bar 188. The handle slope 1882 may form the side surface of the handlebar 188. The handle slope 1882 may be inclined downward in the outward direction.

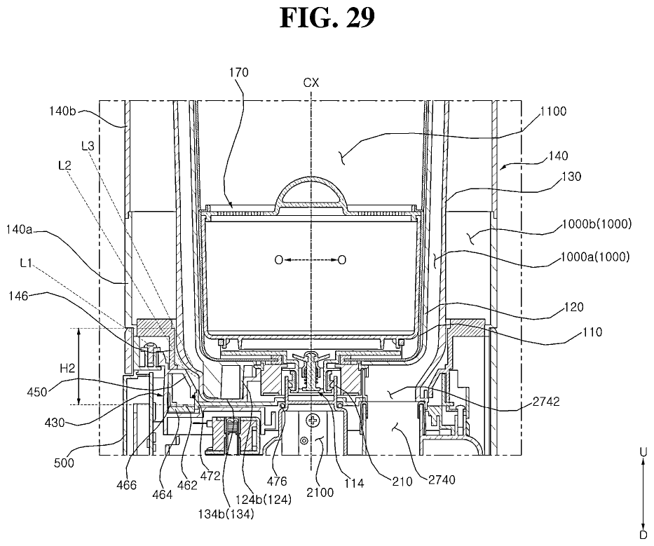

Referring to FIGS. 1 to 33, a humidifier according to one embodiment may include a humidifying device that generates humidified air, and a flow path unit that is disposed in the upper side of the humidifying device and guides humidified air. The flow path unit may include the inner shell 130 that opens upward and through which humidified air generated by the humidifying device flows, and a water tank 100 that is disposed inside of the inner shell 130 and supplies stored water to the humidifying device.

According to another one aspect, a discharge flow path through which humidified air flows may be formed between the inner shell and the water tank.

According to another embodiment, the inner shell may be detachably coupled to the upper side of the humidifying device.

According to another embodiment, the humidifying device may include a supply pipe protruding upward and receiving water from the water tank.

According to another embodiment, the water tank may include an injector detachably coupled to the supply pipe and injecting stored water.

According to another embodiment, the inner shell may include a shell injection hole formed on the bottom surface so that the injector is disposed.

According to another, when the water tank is mounted on the humidifying device, the injector may penetrate the inner shell 130 through the shell injection hole.

According to another embodiment, the humidifying device may include a discharge pipe that opens upward and discharges generated humidified air.

According to another embodiment, the inner shell may include a shell inlet that is detachably connected to the discharge pipe and through which humidified air discharged from the discharge pipe flows.

According to another embodiment, the inner shell may include a shell support that protrudes downward from the lower surface and seats on the humidifying device to support the inner shell.

According to another embodiment, the shell support may include a plurality of shell supports supporting the inner shell, and the plurality of shell supports and the shell inlet may be arranged along the periphery of the shell injection hole.

According to another embodiment, the humidifier may further include a water tank housing that is disposed inside of the inner shell and accommodates the water tank.

According to another embodiment, the discharge flow path may be formed between the inner shell 130 and the water tank housing.

According to another embodiment, the water tank housing may include a housing injection hole formed on the bottom surface so that the injector is disposed.

According to another embodiment, when the water tank is mounted on the humidifying device, the injector may penetrate the inner shell and the water tank housing through the shell injection hole and the housing injection hole.

According to another embodiment, the water tank housing may be inserted into the inner shell or pulled out from the inner shell through the opening in the upper side of the inner shell.

According to another embodiment, the water tank housing may have an opening in the upper side thereof.

According to another embodiment, the water tank may be inserted into the water tank housing or pulled out from the water tank housing through the opening in the upper side of the water tank housing.

According to another embodiment, the water tank housing may include a housing support that protrudes downward from the lower surface and seats on the bottom surface of the inner shell.

According to another embodiment, the lower surface of the water tank housing may be separated upward from the shell inlet through the housing support.

According to another embodiment, the inner shell may include a shell support that protrudes downward from the lower surface and seats on the humidifying device to support the inner shell; and a support insertion unit recessed from the bottom surface and formed inside of the shell support.

According to another embodiment, the housing support may be disposed in the support insertion unit and aligned with the shell support in the vertical direction.

According to another embodiment, the humidifying device may include a middle tray forming an upper end and on which the inner shell is seated.

According to another embodiment, the middle tray may include a middle outlet corresponding to the shell inlet and the discharge pipe.

According to another embodiment, the middle tray may include a protruding platform that protrudes from the upper surface and forms a support seating portion on which the shell support is disposed.

According to another embodiment, the humidifier may further include a discharge grill detachably coupled to the upper end of the inner shell; and a water tank cover disposed at the center of the discharge grill and disposed on the upper side of the water tank.

According to another one embodiment, the water tank cover may be detachably coupled to the discharge grill.

Embodiments disclosed herein provide a humidifier that enhances user convenience.

Embodiments disclosed herein further provide a humidifier with improved hygiene features.

Embodiments disclosed herein furthermore provide a humidifier that is easily washable.

Embodiments disclosed herein also provide a water supply module with a simplified structure.

Embodiments disclosed herein additionally provide a humidifier with a structure that is easily disassembled.

Embodiments disclosed herein provide a humidifier with a structure that enables a user to easily reassemble disassembled parts.

Embodiments disclosed herein provide a humidifier with improved load detection accuracy.

Embodiments disclosed herein provide a humidifier with improved water level detection accuracy.

Embodiments disclosed herein provide a humidifier with improved durability.

Embodiments disclosed herein provide a humidifier with a reduced risk of submersion.

Embodiments disclosed herein provide a humidifier in which a water tank and weight measurement sensors are separated.

Advantages are not limited to those described above. Other technical advantages not mentioned above may be understood clearly by those skilled in the art from the descriptions given below.

Embodiments disclosed herein provide a humidifier that may include a humidifying device generating humidified air, and a flow path unit disposed in the upper side of the humidifying device and guiding humidified air. The flow path unit may include an inner shell that opens upward and through which humidified air generated by the humidifying device flows, and a water tank disposed inside of the inner shell and supplying stored water to the humidifying device. A discharge flow path through which humidified air flows may be formed between the inner shell and the water tank. The inner shell, which is detachably coupled to the upper side of the humidifying device and forms a discharge flow path through which humidified air flows, may be separated from the humidifying device.

The humidifying device may include a supply pipe that protrudes upward and receives water from the water tank. The water tank may include an injector that is detachably coupled to the supply pipe and injects stored water. The water tank forming a discharge flow path may be separated from the supply pipe of the humidifying device.

The inner shell may include a shell injection hole formed on the bottom surface so that the injector is disposed. As the injector penetrates the inner shell through the shell injection hole when the water tank is mounted on the humidifying device, the water tank may be connected to the humidification device through the inner shell.

The humidifying device may include a discharge pipe that opens upward and discharges generated humidified air. The inner shell may include a shell inlet that is detachably connected to the discharge pipe and through which humidified air discharged from the discharge pipe flows. Humidified air discharged from the humidifying device may flow inside of the inner shell through the shell inlet.

The inner shell may include a shell support that protrudes downward from the lower surface and seats on the humidifying device to support the inner shell. The inner shell may be seated on the upper side of the humidifying device through the shell support.

The water tank may include an injector for injecting water stored in the humidifying device. The inner shell may include a shell injection hole formed on the bottom surface so that the injector is disposed. The shell support may include a plurality of shell supports supporting the inner shell. The plurality of shell supports and the shell inlet may be arranged along the periphery of the shell injection hole, thereby guiding a coupling direction to the user through the plurality of shell supports and the shell inlet formed in the inner shell.

The humidifier may further include a water tank housing that is disposed inside of the inner shell and accommodates the water tank. The discharge flow path may be formed between the inner shell and the water tank housing.

The water tank may include an injector for injecting stored water to the humidifying device. The inner shell may include a shell injection hole formed on the bottom surface so that the injector is disposed. The water tank housing may include a housing injection hole formed on the bottom surface so that the injector is disposed, and when the water tank is mounted on the humidifying device, the injector may penetrate the inner shell and the water tank housing through the shell injection hole and the housing injection hole, thereby connecting the water tank to the humidifying device.

The water tank housing may be inserted into the inner shell or pulled out from the inner shell through the opening in the upper side of the inner shell. The user may separate or combine the water tank housing through the opening in the upper side of the inner shell.

The water tank housing has an opening in the upper side thereof. The water tank may be inserted into the water tank housing or pulled out from the water tank housing through the opening in the upper side of the water tank housing, and the user may separate or combine the water tank through the opening in the upper side of the water tank housing.

The water tank housing may include a housing support that protrudes downward from the lower surface and seats on the bottom surface of the inner shell, and the water tank housing may be detachably seated on the inner shell.

The humidifying device may include a discharge pipe that opens upward and discharges generated humidified air. The inner shell may include a shell inlet that is detachably connected to the discharge pipe and through which humidified air discharged from the discharge pipe flows. The lower surface of the water tank housing may be separated upward from the shell inlet through the housing support, and humidified air introduced through the shell inlet may flow between the bottom surface of the inner shell and the lower surface of the water tank housing.

The inner shell may include a shell support that protrudes downward from the lower surface and seats on the humidifying device to support the inner shell and a support insertion unit recessed from the bottom surface and formed inside of the shell support. The housing support may be disposed in the support insertion unit and aligned with the shell support in the vertical direction, thereby guiding an assembly direction of the water tank housing to the user through the assembly structure of the shell support and the support insertion unit.

The humidifying device may include a middle tray forming an upper end and on which the inner shell is seated. The middle tray may include a middle outlet corresponding to the shell inlet and the discharge pipe, thereby guiding an assembly direction of the inner shell to the user through the assembly structure of the middle outlet and the shell inlet.

The middle tray may include a protruding platform that protrudes from the upper surface and forms a support seating portion on which the shell support is disposed, thereby guiding assembly of the inner shell.

The humidifier may further include a discharge grill detachably coupled to the upper end of the inner shell and a water tank cover disposed at the center of the discharge grill and disposed on the upper side of the water tank. The water tank cover may be detachably coupled to the discharge grill.

The middle tray may include a load sensor placed on the upper surface to detect the load. The water tank housing may include a first housing support that extends downward from the bottom surface and applies pressure on the load sensor. The first housing support may transfer a weight of water stored in the water tank to the load sensor.

The water tank housing may include a second housing support extending downward from the bottom surface and seating on the upper surface of the middle tray. The first housing support may include a pair of first housing supports spaced apart to face each other in the radial direction, by which the second housing support may support the water tank housing.

The water tank may include an injector that injects stored water to the humidifying device. The water tank housing may include a housing injection hole formed on the bottom surface and through which the injector penetrates, by which water stored in the water tank contained in the water tank housing may be supplied to the humidifying device through the housing injection hole.

The humidifier may include a water tank housing disposed inside thereof, and an inner shell spaced outwardly from the water tank housing. A first discharge flow path through which mist flows may be formed between the water tank housing and the inner shell.

The inner shell may include a first shell support extending downward from the lower surface and applying pressure on the load sensor. The first shell support may transfer a weight of the upper portion to the load sensor.

The inner shell may include a first support insertion unit recessed from the inner bottom surface into the inside of the first shell support and on which the first housing support is seated, and the first housing support may transfer load to the first shell support. The inner shell may include a second shell support extending downward from the lower surface and seating on the upper surface of the middle tray, and the second shell support may support the inner shell.

The inner shell may include a second support insertion unit recessed from the inner bottom surface into the inside of the second shell support and on which the second housing support is seated, and the second housing support may transfer load to the second shell support. The inner shell may include a shell injection hole formed on the lower surface and through which the injector passes, and water stored in the water tank contained in the inner shell may be supplied to the humidifying device through the shell injection hole.

The humidifying device may include a humid air outlet for discharging generated mist and a shell inlet formed on a lower surface to connect the humid air outlet and the first discharge flow path. The mist generated by the humidifying device may flow through the first discharge flow path formed inside of the inner shell.

The inner shell may include a protruding rib extending downward from the periphery forming the shell inlet and seating on the upper surface of the middle tray, and the protruding rib may support the inner shell together with the shell support. The middle tray may include a protruding platform that protrudes upward from the upper surface to guide installation of the second shell support, thereby fixing the second shell support to prevent it from being separated in the horizontal direction.

The load sensor may include a contact plate exposed and pressed on the upper surface of the middle tray, a sensor board mounted inside of the middle tray, and a presser extending downward from the contact plate to transfer the pressure applied to the contact plate to the sensor board. The middle tray may include a recess in which the contact plate is disposed by being submerged from the upper surface to the lower side, and a through hole is formed in the recess into which the presser is inserted. The middle tray may include a stopper that protrudes upward from the periphery of the through hole and inhibits downward movement of the contact plate, thereby protecting the load sensor from potential damage.

A sealer may be disposed between the recess and the contact plate to seal a gap formed between the recess and the contact plate, thereby preventing submersion of the load sensor. The sealer may be made of an elastic material and may buffer the applied load. The sealer may be an annular sealer extending along the periphery of the recess, with a circular cross-section perpendicular to the extension direction, thereby improving compressibility.

The middle tray may include a stopper that protrudes upward from the periphery of the through hole and inhibits downward movement of the contact plate. The sealer may be disposed between the stopper and the peripheral wall forming the recess. A cross-sectional diameter of the sealer may be smaller than a gap between the stopper and a peripheral wall forming the recess, thereby forming a space in which the sealer may be compressed.

The humidifying device may include a supply pipe protruding upward so that the injector is mounted. The middle tray may include a middle injection hole through which the supply pipe passes. The middle tray may include an injection rib that extends along the periphery of the middle injection hole and protrudes upward, thereby reducing the amount of residual water accumulated on the upper surface of the middle tray, which flows into the middle injection hole.

The middle tray may include a middle outlet through which the mist generated from the humidifying device is discharged and a discharge rib extending along the periphery of the middle outlet and protruding upward, thereby reducing the amount of residual water accumulated on the upper surface of the middle tray, which flows into the middle inlet.

The humidifier may include a cylindrical case in which the humidifying device, the water tank, the water tank housing, the inner shell, and the middle tray are disposed, and of which the upper side is open; and an annular discharge grill disposed on the open upper side of the case. A second discharge flow path may be formed between the case and the inner shell, and the discharge grill may be separated upward from the inner shell to prevent the load of the discharge grill from being transferred to the inner shell.

The humidifier may include a water tank cover that covers the open upper side of the water tank. The water tank cover may be mounted on the inner periphery of the discharge grill and separated from the water tank to prevent the load of the water tank cover from being transferred to the water tank.

Embodiments disclosed herein provide a humidifier that may include a case having an outlet of which the upper side is open; a humidifying device disposed inside of the case and generating mist; a water tank having a water storage space opened upward and disposed in the upper side of the humidifying device; a water tank cover covering the open upper side of the water tank; a discharge grill disposed on an open upper side of the case; and a middle tray disposed between the humidifying device and the water tank housing. A discharge flow path may be formed between the case and the water tank. The middle tray may include a load sensor located on the upper surface to detect the load of the water tank. The case may include a protruding seating portion that protrudes inward from the inner circumferential surface and on which the discharge grill is seated, and the water tank cover may be seated on the discharge grill and separated from the water tank.

According to at least one of the embodiments disclosed herein, an inner shell may form a discharge flow path through which humid air discharged from the humidifying device flows, and the inner shell may be detachably combined with the humidifying device, thereby enabling the user to easily separate and clean the flow path structure.

According to at least one of the embodiments disclosed herein, the injector of the water tank may be detachably combined with the humidifying device, thereby enabling the user to separate the water tank from the humidifying device and clean the water tank.

According to at least one of the embodiments disclosed herein, the inner shell may include a shell injection hole through which the injector penetrates, the water tank is mounted inside of the inner shell through the shell injection hole, and a discharge flow path may be formed between the inner shell and the water tank through which humidified air flows. Also, as the water tank may be detached from the humidifying device, the user may easily clean the outer periphery of the water tank that constitute the humidifying flow path. This feature enhances the hygiene and ease of maintenance of the humidifier.

According to at least one of the embodiments disclosed herein, the inner shell may include a shell inlet; the inner shell may be detached from the humidifying device; moreover, the shell inlet corresponding to the discharge pipe may guide an assembly direction to the user.

According to at least one of the embodiments disclosed herein, the inner shell may include a shell support that protrudes downward from the lower surface and seats on the humidifying device to support the inner shell; the inner shell may be detachably combined with the humidifying device in a way to be seated on the upper surface of the humidifying device.

According to at least one of the embodiments disclosed herein, a plurality of shell supports and a shell injection hole may be arranged along the periphery of the shell inlet in the inner shell, thereby determining the direction in which the inner shell is combined with the humidifying device. Through this feature, an assembly direction may be guided while a user reassembles the inner shell detached from the humidifying device.

According to at least one of the embodiments disclosed herein, the humidifier may further include a water tank housing that is disposed inside of the inner shell and accommodates the water tank, and the discharge flow path may be formed between the inner shell and the water tank housing.

According to at least one of the embodiments disclosed herein, the water tank housing may include a housing injection hole through which an injector may pass, and the water tank disposed within the water tank housing may penetrate the housing injection hole to be connected to the humidifying device.

According to at least one of the embodiments disclosed herein, the inner shell in which a water tank housing is disposed may have an opening in the upper side thereof, and the water tank housing may be inserted into the inner shell or pulled out from the inside of the inner shell through the opening in the upper side of the inner shell. Through this feature, the user may pull out the water tank housing that forms a discharge flow path from the inner shell and clean the water tank housing.

According to at least one of the embodiments disclosed herein, the water tank housing in which a water tank is disposed may have an opening in the upper side thereof, and the water tank may be inserted into the water tank housing or pulled out from the inside of the water tank housing through the opening in the upper side of the water tank housing. Through this feature, the user may pull out the water tank from the water tank housing and clean the water tank.

According to at least one of the embodiments disclosed herein, the water tank housing may include a housing support seated on the bottom surface of the inner shell so that the water tank housing is stably supported inside of the inner shell. Also, the lower surface of the water tank housing may be separated from the bottom surface of the inner shell through the housing support, thereby forming a discharge flow path even between the lower surface of the water tank housing and the bottom surface of the inner shell.

According to at least one of the embodiments disclosed herein, the inner shell may include a support insertion unit through which the housing support of the water tank housing is disposed, thereby guiding an assembly direction of the water tank housing while the water tank housing separated from the inner shell is reassembled by the user back to the inner shell. Also, as the housing support is disposed in the support insertion unit formed inside of the shell support, and the housing support is aligned with the shell support in the vertical direction, the water tank housing may be supported more stably within the inner shell.

According to at least one of the embodiments disclosed herein, the middle tray may include a middle outlet corresponding to the shell inlet of the inner shell, thereby guiding an assembly direction while the user combines the inner shell with the middle tray.

According to at least one of the embodiments disclosed herein, the middle tray may include a middle outlet corresponding to the discharge pipe of the humidifying device, thereby guiding an assembly direction while the user combines the middle tray with the humidifying device.

According to at least one of the embodiments disclosed herein, the middle tray may include a support seating portion in which a shell support is disposed, thereby guiding an assembly direction along which the inner shell is coupled to the middle tray.

According to at least one of the embodiments disclosed herein, the middle tray may include a protruding platform that protrudes from the upper surface and forms a support seating portion, thereby fixing the shell support of the inner shell coupled to the middle tray.

According to at least one of the embodiments disclosed herein, the humidifier may include a discharge grill detachably coupled to the upper end of the inner shell and a water tank cover detachably coupled to the discharge grill, thereby enabling the user to separately clean the discharge grill through which humidified air flows and the water tank cover coupled to the water tank. Also, the water tank cover may be separated from the water tank to clean the inside of the water tank.

According to at least one of the embodiments disclosed herein, as the first housing support concentrates the load of the water tank on the load sensor, accuracy of detecting the weight of water stored in the water tank may be improved.

According to at least one of the embodiments disclosed herein, as the second housing support prevents the water tank from tilting and prevents the water tank from tipping over, the load of the water tank may be uniformly distributed over a plurality of the first housing supports. Also, the accuracy of detecting the weight of water stored in the water tank may be improved.

According to at least one of the embodiments disclosed herein, the accuracy of detecting the load and water level may be improved due to the discharge grill separated upward from the inner shell.

According to at least one of the embodiments disclosed herein, the accuracy of detecting the load and water level may be improved due to the water tank cover separated upward from the water tank.

According to at least one of the embodiments disclosed herein, the user may separate the water tank from the load sensor and clean the water tank by using the water tank detachable from the load sensor, the water tank housing, and the inner shell structure.

According to at least one of the embodiments disclosed herein, as the first shell support concentrates the load of the inner shell on the load sensor, accuracy of detecting the weight of water stored in the water tank may be improved.

According to at least one of the embodiments disclosed herein, the second shell support prevents the water tank from tilting and prevents the water tank from tipping over, the load of the water tank may be uniformly distributed over a plurality of the first housing supports. Also, the accuracy of detecting the weight of water stored in the water tank may be improved.

According to at least one of the embodiments disclosed herein, as the protruding rib, together with the second shell support, prevents the inner shell from tipping over, the accuracy of detecting the load of water stored in the water tank may be improved.

According to at least one of the embodiments disclosed herein, durability of the humidifier may be improved due to the stopper that prohibits the movement of the load sensor.

According to at least one of the embodiments disclosed herein, a risk of internal submersion of the humidifier may be reduced due to the sealer disposed on the load sensor.

According to at least one of the embodiments disclosed herein, durability of the humidifier may be improved due to the sealer that acts as a buffer in the lower side of the load sensor.

According to at least one of the embodiments disclosed herein, the risk of internal flooding of the humidifier may be reduced due to the injection rib that protrudes upward and the discharge rib.

Advantages are not limited to the Advantages described above, and other Advantages not mentioned herein may be understood clearly to those skilled in the art from the description of the appended claims.

Embodiments described above are not mutually exclusive or distinct from each other. Any or all elements of the embodiments described above may be combined with another or combined with each other in configuration or function).

For example, a configuration “A” described in one embodiment and the drawings and a configuration “B” described in another embodiment and the drawings may be combined with each other. Namely, although the combination between the configurations is not directly described, the combination is possible except in the case where it is described that the combination is impossible.

The detailed descriptions above should be regarded as being illustrative rather than restrictive in every aspect. The technical scope should be determined by a reasonable interpretation of the appended claims, and all of the modifications that fall within an equivalent scope belong to the technical scope.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles. More particularly, various variations and modifications are possible in the component parts and/or arrangements of the subject combination arrangement within the scope, the drawings and the appended claims. In addition to variations and modifications in the component parts and/or arrangements, alternative uses will also be apparent to those skilled in the art.

What is claimed is:

1. A humidifier, comprising:
a humidifying device configured to generate humidified air; and
a flow path unit disposed above the humidifying device and configured to guide humidified air, wherein the flow path unit comprises an inner shell that opens upward and through which humidified air generated by the humidifying device flows; and
a water tank disposed inside of the inner shell and configured to supply stored water to the humidifying device, wherein a discharge flow path through which humidified air flows is defined between the inner shell and the water tank, and wherein the inner shell is detachably coupled to an upper side of the humidifying device.

2. The humidifier of claim 1, wherein the humidifying device comprises a supply pipe that protrudes upward and is configured to receive water from the water tank, and wherein the water tank comprises an injector that is detachably coupled to the supply pipe and configured to inject stored water into the supply pipe.

3. The humidifier of claim 2, wherein the inner shell comprises a shell injection hole defined in a bottom surface thereof, and wherein the injector penetrates the inner shell through the shell injection hole when the water tank is mounted on the humidifying device.

4. The humidifier of claim 1, wherein the humidifying device comprises a discharge pipe that opens upward and is configured to discharge generated humidified air, and wherein the inner shell comprises a shell inlet that is detachably connected to the discharge pipe and through which humidified air discharged from the discharge pipe flows.

5. The humidifier of claim 4, wherein the inner shell comprises at least one shell support that protrudes downward from a lower surface, is seated on the humidifying device, and supports the inner shell.

6. The humidifier of claim 5, wherein the water tank comprises an injector that injects water stored in the water tank into the humidifying device, wherein the inner shell comprises a shell injection hole defined in a bottom surface thereof, wherein the at least one shell support comprises a plurality of shell supports that supports the inner shell, and wherein the plurality of shell supports and the shell inlet are arranged along a periphery of the shell injection hole.

7. The humidifier of claim 5, wherein the humidifying device comprises a middle tray that defines an upper end thereof and on which the inner shell is seated, and wherein the middle tray comprises a middle outlet corresponding to the shell inlet and the discharge pipe.

8. The humidifier of claim 7, wherein the middle tray comprises at least one protruding platform that protrudes from an upper surface thereof and defines a support seating portion on which the at least one shell support is disposed.

9. The humidifier of claim 1, further comprising a water tank housing that is disposed inside of the inner shell and accommodates the water tank, and wherein the discharge flow path is defined between the inner shell and the water tank housing.

10. The humidifier of claim 9, wherein the water tank comprises an injector that injects water stored in the water tank into the humidifying device, wherein the inner shell comprises a shell injection hole defined in a bottom surface thereof, wherein the water tank housing comprises a housing injection hole defined in a bottom surface thereof, and wherein the injector penetrates the inner shell and the water tank housing via the shell injection hole and the housing injection hole when the water tank is mounted on the humidifying device.

11. The humidifier of claim 9, wherein the water tank housing is inserted into the inner shell or pulled out from the inner shell through an opening at an upper side of the inner shell.

12. The humidifier of claim 9, wherein the water tank housing has an opening in an upper side thereof, and wherein the water tank is inserted into the water tank housing or pulled out from the water tank housing through the opening in the upper side of the water tank housing.

13. The humidifier of claim 9, wherein the water tank housing comprises at least one housing support that protrudes downward from a lower surface thereof and is seated on a bottom surface of the inner shell.

14. The humidifier of claim 13, wherein the humidifying device comprises a discharge pipe that opens upward and is configured to discharge generated humidified air, wherein the inner shell comprises a shell inlet that is detachably connected to the discharge pipe and in which humidified air discharged from the discharge pipe flows, and wherein a lower surface of the water tank housing is spaced upward from the shell inlet through the at least one housing support.

15. The humidifier of claim 13, wherein the inner shell comprises at least one shell support that protrudes downward from the lower surface, is seated on the humidifying device, and supports the inner shell, wherein a support insertion unit is recessed from a bottom surface of the at least one shell support and defined inside of the at least one shell support, and wherein the at least one housing support is disposed in the support insertion unit and aligned with the at least one shell support in a vertical direction.

16. The humidifier of claim 1, further comprising:
a discharge grill detachably coupled to an upper end of the inner shell; and
a water tank cover disposed at a center of the discharge grill and disposed above the water tank, wherein the water tank cover is detachably coupled to the discharge grill.

17. A humidifier, comprising:
a case;
a humidifying device that is disposed within the case and configured to generate humidified air; and
a flow path unit disposed within the case above the humidifying device and configured to guide humidified air, wherein the flow path unit comprises:
a water storage space;
a first discharge flow path; and
a first outlet, wherein water storage space includes a water tank disposed inside of an inner shell and configured to supply stored water to the humidifying device through a supply pipe disposed at a lower surface of the water tank, wherein the first discharge flow path through which humidified air flows is defined between the inner shell and the water tank, and wherein the first outlet is defined at an upper surface of the case and communicates with the first discharge flow path.

18. The humidifier of claim 17, wherein the inner shell is detachably coupled to an upper side of the humidifying device.

19. The humidifier of claim 17, wherein the flow path unit further comprises an outer shell in which the inner shell is disposed, wherein the humidifier further comprises a blower fan, wherein a second discharge flow path is defined between the outer shell and the case, and where a second outlet in communication with the second discharge flow path is defined at the upper surface of the case.

20. The humidifier of claim 19, further comprising a blower flow path that communicates with the blower fan and guides air to the second discharge flow path.
